(19) United States
(12) Patent Application Publication
(10) Pub. No.: US 2025/0249339 A1
(43) Pub. Date: Aug. 7, 2025

(54) EVENT DATA IMMERSION SYSTEM

(71) Applicant: PGA TOUR Enterprises, LLC, Ponte Vedra Beach, FL (US)

(72) Inventors: Matthew Mullen, Ponte Vedra Beach, FL (US); Eric Hanson, Ponte Vedra Beach, FL (US); Wendy Balogh, Ponte Vedra Beach, FL (US); Scott Gutterman, Ponte Vedra Beach, FL (US)

(73) Assignee: PGA TOUR Enterprises, LLC, Ponte Vedra Beach, FL (US)

(21) Appl. No.: 19/044,610

(22) Filed: Feb. 3, 2025

Related U.S. Application Data
(60) Provisional application No. 63/548,849, filed on Feb. 2, 2024.

(51) Int. Cl. A63B 71/06; A63B 24/00; A63B 102/32

(52) U.S. Cl. CPC A63B 71/0622; A63B 24/0021; A63B 71/0669; A63B 2024/0028; A63B 2024/0053; A63B 2071/0638; A63B 2102/32; A63B 2220/807; A63B 2220/89

(57) ABSTRACT

A system for providing an extended reality environment that incorporates real-world event data into 3D models representative of the real-world event within the extended reality environment includes an XR processing unit configured to dynamically download 3D hole models of the course, receive real-world live shot data of shots taken on the holes during a golf tournament; map the shot data to the 3D hole models; and cause a spatial computing device to render hole views and immersive views comprising the mapped shot data rendered directly on the 3D hole models in real-time in an interactive extended reality environment. The mapped shot data includes shot trails representative of the shots taken on the golf course, The hole views and immersive views may utilize the same source file.

### CROSS-REFERENCE TO RELATED APPLICATIONS

The present application claims priority to U.S. Provisional Patent Application 63/548,849, filed Feb. 2, 2024. The contents of which are hereby incorporated herein by reference.

### TECHNOLOGY

The present disclosure is directed to a system providing an immersion experience within a spatial computing environment that incorporates live event data, more specifically live sporting event data such as professional golf tournament event data.

### BACKGROUND

Sports and other live events are often broadcast on television and online. Graphics for these broadcasts as well as for onsite presentation may be generated and presented to viewers during the event to improve the viewing experience by incorporating information about the event in a visually concise and interesting format. One example viewing experience is TOURCAST®, owned by PGA TOUR Enterprises, LLC, which is provided online to viewers via a web application to enrich professional golf tournament viewing. the viewing tournament viewing. TOURCAST® provides a next-generation digital experience with every shot from every player including dynamic shot trails, radar data, green view, player and tournament stats, and video highlights to allow users to follow everything live to the minute or catch up on favorite players after the round. Despite the groundbreaking enhancements to the viewing experience provided by TOURCAST®, some fans crave yet a deeper experience. What is needed is improved systems and methods of dissemination and consumption of live event data, particularly for sporting events such as golf tournaments, to further enhance the fan viewing experience.

### BRIEF DESCRIPTION OF THE DRAWINGS

The novel features of the described embodiments are set forth with particularity in the appended claims. The described embodiments, however, both as to organization and manner of operation, may be best understood by reference to the following description, taken in conjunction with the accompanying drawings in which:

FIG. 1 is a schematic of a system for delivering immersive live event data content to users in a spatial computing environment according to various embodiments described herein;

FIG. 2 is an example of an interactive course information panel and navigation and information interfaces within an extended reality rendering according to various embodiments described herein;

FIG. 3 is an example of an interactive video panel and navigation and information interfaces within an AR rendering according to various embodiments described herein;

FIG. 4 is an example of an interactive leaderboard panel view and navigation and information interfaces within an extended reality rendering according to various embodiments described herein;

FIG. 5 is an example of an interactive scorecard panel, navigation and information interfaces, and a 3D hole view within an extended reality rendering according to various embodiments described herein;

FIG. 6 is an example of an interactive scorecard panel, navigation and information interfaces, and a 3D hole view within an extended reality rendering according to various embodiments described herein;

FIG. 7 is an example of an immersion green view within a 3D hole model rendering and including an interactive scorecard panel along with navigation and information interfaces according to various embodiments described herein;

FIG. 8 is an example of an immersion green view within a 3D hole model rendering and including an interactive scorecard panel, navigation and information interfaces, and a video panel according to various embodiments described herein;

FIG. 9 is an example of a 3D course model rendering providing a course view incorporating tournament play statistics for each hole according to various embodiments described herein;

FIG. 10 is an example of a 3D course model rendering providing a course view with remaining holes for a group highlighted according to various embodiments described herein;

FIG. 11 is an example scatter plot view overlaid within a 3D hole model rendering depicting first shot locations of players and respective hole scores for competing players according to various embodiments described herein;

FIG. 12 depicts a method of mapping live data with a 3D hole model rendering to provide an immersive hole viewing experience according to various embodiments described herein; and

FIG. 13 s a schematic diagram of a machine in the form of a computer system within which a set of instructions, when executed, may cause the machine to render 3D models and provide an immersive spatial computing environment that overlays live event data within the 3D models according to various embodiments described herein.

### DESCRIPTION

In various embodiments, a system is provided that is configured to render 3D models in an immersive extended reality environment, dynamically map live event data to the 3D models, and accurately overlay the live event data within the model.

The system may include or be in data communication with an XR processing unit that executes an extended reality application enabling users to follow live sport events, such as professional golf tournaments, using spatial computing devices providing a extended reality environment. While the present disclosure generally describes the system and operations with respect to golf, in particular a golf tournament, those having skill in the art will appreciate upon reading the present disclosure that the system and operations may be similarly adapted for use with respect to other sports and events to accurately integrate real-world event data or data derived therefrom into an extended reality environment, such as an immersive interactive extended reality environment. The system may be configured to cause displays within the extended reality environment of key tournament information like leaderboards, scorecards, and video. The displays may be provided in 2D windows. These 2D windows, which may also be referred to herein as panels, may provide interactive resources for users to view desired information and formats, navigate the extended reality environment, or combination thereof.

The system may be configured to cause immersive 3D-renderings of hole models configured for user interaction to view desired event data. Various types of event data may be available such as live event data or other event associated data, which may include historical statistics, play from previous tournaments, player information, sponsor information, equipment information, or other event associated data. For example, users may be presented with 3D course or hole models in an extended reality environment and the system may cause integration of mapped shot trails that depict shots of players in the tournament, including live shots, automatically or when requested by the user. In a live play use case, a user may navigate to a hole to view live action occurring on the hole. For instance, the system may map shot trails from actual live shot data captured during the tournament for display to the user. The system may interpret shot data collected by ball tracking sensors positioned on the golf course during actual play and cause a shot trail to be displayed to the user that represents the actual ball flight within the extended reality environment with respect to the 3D hole model of the hole the shot occurred, as if the user is present on the course. The system may be configured to receive user interactions with the 3D model renderings and modify a location within the 3D model from which it is rendered to users. That is, the user may interact with the extended reality environment to change the location or perspective with respect to the 3D model that the user is presented. For example, in one embodiment, movement by the user may be used to cause movement of the perspective of the user within the 3D model such that the extended reality view presented to the user corresponds to different locations within the model to view the event data. The experience may be immersive such that the extended reality view presented is scaled to that of a human and the human experience as if the user were present on the hole.

As introduced above, the system may overlay event data, including live event data, on 3D models. One example of such event data is a shot trail. A shot trail may include a visual representation of a flight path taken by a golf ball. For example, a shot trail may comprise a line that connects a starting point of ball when struck and the final location the ball stops on the hole. Shot trails may also trace the complete path of the ball from strike to final resting position, which may include bounce and roll path. The system may be configured to map the shot trails to the 3D model for accurate depiction of the shot trails within the viewing experience displayed to the users. In one embodiment, the system may map and overlay shot trails such that each shot a player or group players take on a hole will be displayed until their golf ball reaches the hole. Shot trails may include various flight path representations within the extended reality environment that correspond to the real-world ball flight of the actual ball on the hole. For example, shot trails may represent the apex the golf ball reached, flight path shape, or both. For example, event data may include radar or other sensor data that track one or more ball flight parameters such as flight path, launch angle, acceleration, or velocity. When multiple shot trails are displayed, the shot trails may include distinguishing indicia to identify the players that hit the balls represented by the shot trails or to otherwise distinguish between or among the multiple shot trails, which may include identification of shot number. For example, each player may be associated with a shot trail marking such as a broken line pattern or line design. In another example, each player may be associated to a shot trail using color coordination of the shot trails.

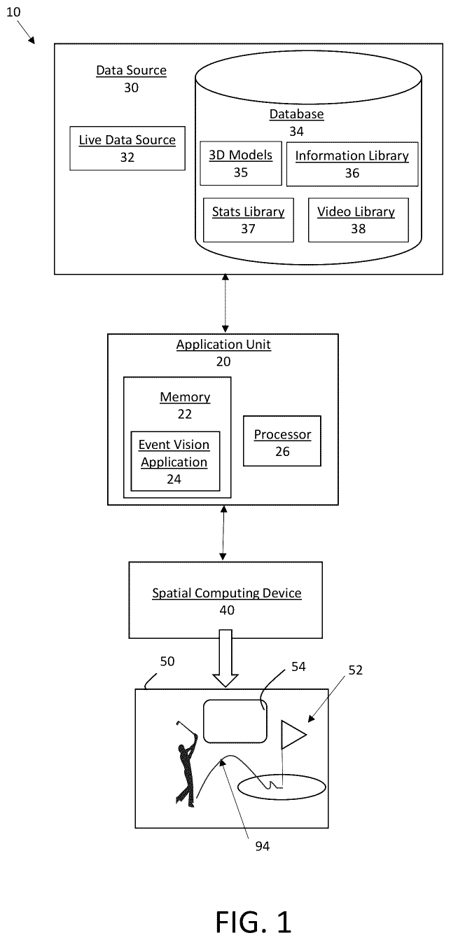

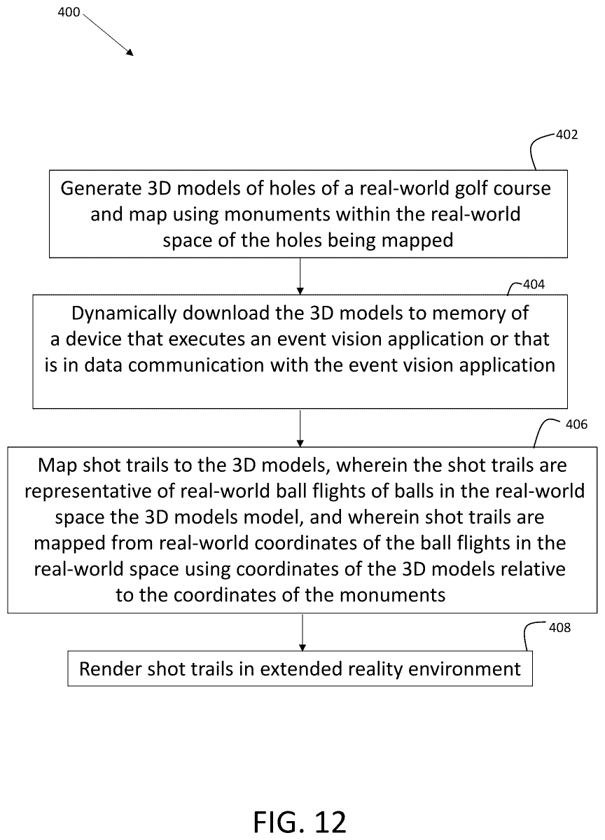

FIGS. 1-13 illustrate features, configurations, and components of a system 10 configured to render 3D models 35 in an immersive extended reality environment that dynamically overlays the 3D models 35 with live event data according to various embodiments wherein like features are identified by like numbers.

With particular reference to FIG. 1, the system may include an XR processing unit 20. The XR processing unit 20 may include memory 22 and a processor 24. The memory 22 may store instructions that when executed by the processor perform the operations of the XR processing unit 20. In some embodiments, the instructions may comprise an event vision application 24.

The system 10 may include or be configured to be in wired or wireless communication with one or more data sources 30 to receive event data or other data from the data source 30. The data source 30 may include one or more data sources 30 comprising one or more databases, which may include data services, data structures (e.g., data buckets such as object based storage), or any other data source that maintains or is otherwise configured to provide the data for the operations of the system 10. The data source 32 may be configured t provide event data to the XR processing unit 20 or other components of the system 10. Event data may include any data related to the event such as the course or other playing field, the competitors, the sport (e.g., golf), related leagues or competitions, stats, equipment used by the competitors, competition rules, or history, sponsors, sponsorships, or live data related to any of the forgoing. In the example illustrated, the data source 30 includes a database 34 comprising one or more databases. The database 34 may comprising 3D models 35. The 3D models 35 may be generated as described herein or by other suitable methods known to those skilled in the art.

The 3D models 35 may comprise course models, which may be 2D, 3D, or both. The 3D models 35 may comprise 3D hole models. In one embodiment, 3D hole models may be configured to be processed and rendered to provide multiple views and perspectives at multiple perceptible scales. The perceptible scale to which views are rendered may include those corresponding to that of the human experience, larger, or smaller. The 3D hole model may be rendered in an extended reality display using a spatial computing device 40. The extended reality display may include augmented reality, virtual reality, which may be 360 degree immersion, or mixed reality. In one example, a 3D hole model may be configure to provide an overlook mode wherein an overhead or elevated view is rendered. The overhead view may be rendered from various points of view, scales, or both. In one example, using the spatial computing device 40, the XR processing unit may enable a user to fly around the a hole, course, or surrounding area. In another example, a 3D hole model may be rendered in an immersive mode that is scaled to the human experience as if the user is standing on or around the hole in the physical world. For example, the XR processing unit 20 may be configured to enable a user to enter directly into a 3D hole model within an extended reality environment in an immersive mode and view a hole as if standing on it in the physical world. In the immersive mode, the user may be able to view the hole model from multiple locations to gain different perspectives of the layout and view shots from multiple angles. In some embodiments, the XR processing unit 20 may also be configured to enable users to view 3D hole models, using a spatial computing device 40, from multiple locations, different perspectives, or both in an overlook mode.

The database 34 may also include one or more of an information library 36, stats library 37, or a video library 38. The information library 36 may include information regarding players competing in the event, event schedule, equipment, sponsors, hole information, course history, tournament history, league or championship related standings or schedule, cuts, or other information. The stats library 37 may include event related statistics, such as current event statistics and prior event statistics. The statistics may include individual player statistics, collective statistics for all or multiple players, scoring, shot data including shot coordinates, shot locations, previous cutlines, championship standings, leagues standings, or other statistics. The statistics may relate to statistics on particular holes, types of holes, rounds, tournaments, courses, time periods, seasons, weather conditions, or as otherwise desired. The video library 38 may include video data from the current or past events. The video data may include video of current or past play, shots, courses, holes, rounds, highlights, stories, sponsors, advertisements, playing tips or instruction, advice, or other video.

In some embodiments, the database 34 may include any of the above information with respect to prior events, such as golf tournament events. For example, as described in more detail below, the event vision application 24 may be configured to provide selective replay of tournaments, highlights, video, of the current or previous rounds or tournaments.

The data source 30 may also include a live data source 32 comprising one or more data sources, e.g., databases, which may include data services, data structures (e.g., data buckets such as object based storage), or the like. The live data source 32 may provide live data to the XR processing unit 20. The live data may include live shot data collected by on-course sensors of a tracking network configured to track ball movement or movement of other objects such as players. The sensors may include laser rangefinders, LIDAR, cameras, radar, or other suitable sensors. The sensors and tracking methodology may be similar to that described in U.S. patent application Ser. No. 18/238,234, filed Aug. 25, 2023, the contents of which are hereby incorporated herein by reference. The live data may include starting coordinates and final resting position coordinates of a ball. In a further example, the live data may include starting coordinates, impact coordinates, and final resting position coordinates. In a further example, the live data may include starting coordinates, impact coordinates, one or more bounce or roll coordinates, and final resting position coordinates. In any of the above, the coordinates may also include one or more ball flight coordinates, such as apex coordinates. In one example, the sensors may include radar to collect ball flight parameters such as ball flight coordinates or other ball flight parameters, e.g., velocity, launch angle, flight shape, flight path, decent angle, or apex. In one example, flight path or shape may be calculated using physics based on one or more of the above parameters and the distance between the starting and impact coordinates. In one embodiment, the live data source 32 comprises the PGA TOUR's ShotLink® technology that tracks every shot of every tournament. Coordinates may be provided in any suitable format, such as GPS or a custom defined 3D coordinate space. In some embodiments, the live data source 32 may also provide additional live data, such as scoring, strokes, player locations, live video, produced video highlights, important or impactful play notifications, weather updates, updated cutlines, which may include predicted cutlines, or other live data.

In one embodiment, the live data source 32 comprises updated betting lines for the tournament, such as updated or new odds on prop bets or other wagers. In a further example, the XR processing unit 20 executing the event vision application 24 is configured to cause display of the extended reality environment including a wager platform or interface to a wager platform that allows users to interact with the wager platform to receive lines, odds, or the like and place corresponding wagers via interaction with the extended reality environment. Causing or enabling display and execution of the extended reality environment or incorporation of elements therein may include providing 3D model data, digital content, which may include interactive virtual elements or virtual representation data with respect to real-world objects, spatial mapping with respect to any of the forgoing, processing or rendering instructions with respect to any of the for going, operational instructions with respect to providing an interactive extended reality experience described herein, or combination thereof to the spatial computing device 40 for processing and rendering to display and execute the interactive extended reality environment. In some embodiments, the spatial computing device 40 executes a portion of the event vision application 24, which may include a client-side processing components with respect to any of the forgoing.

The XR processing unit 20 may be in wired or wireless communication with the data source 30 via a communication port (not shown). In one example, the XR processing unit 20, utilizing the communication port, communicates with the data source 30 via one or more APIs. The APIs may include REST API, Web API, push or real-time API, such as an API implementation using WebSocket protocol, or other suitable protocols. The XR processing unit 20 may transmit requests or calls for live or other database data. The XR processing unit 20 may transmit requests or calls for data on-demand as required to respond to user interaction with the extended reality environment and cause incorporation or display of the data within rendered elements. In one embodiment, the XR processing unit 20 subscribes to live event data with the live data source 32, e.g., via a real-time data feed or data push API, such as one using WebSocket protocol, or the like, to receive live event data when it becomes available in real-time.

The XR processing unit 20 is configured to cause a spatial computing device 40 to output an extended reality display 50 as described herein. The XR processing unit 20 may be local or remote with respect to the spatial computing device 40 and receive output instructions from and transmit detected user interactions to the XR processing unit 20 by wired or wireless communication.

In one embodiment, the XR processing unit 20 is integrated with the spatial computing device 40 or the spatial computing device 40 includes memory 22 and processor 26 and all or part of the event vision application 24 is stored in memory 22 to perform all or a part of the operations described herein with respect to the XR processing unit 20. For example, the event vision application 24 may comprise a native executable program stored and executed on the spatial computing device 40. In one configuration, one or more aspects of the event vision application 24 may be stored, executed, or both by or in conjunction with another device. For example, all or part of the event vision application 24 may be stored, executed, or both on one or more local or remote data storage devices or processors, as the case may be, in wired or wireless communication with the spatial computing device 40. The spatial computing device 40 may then generate and render the interactive displays described herein, which may be fed, in whole or in part, by one or more local or remote data sources 30. In one embodiment, the event vision application 24 comprises a web application delivered in whole or in part over a browser interface to the spatial computing device 40 by the XR processing unit 20 or another device. In one embodiment, the event vision application 24 comprises a hybrid application including an embedded browser within a native platform. In one configuration, the event vision application comprises a cross-platform application.

The system 10 may implement extended reality, such as virtual, augmented reality, mixed reality, or combination thereof to provide an immersive golf tournament event data consumption experience. Non-limiting examples of spatial computing devices 40 include virtual devices, augmented reality devices, mixed reality devices, or combination thereof. Augmented reality devices may include glasses or headsets, e.g., Microsoft HoloLens or Magic Leap. Virtual reality devices may include headsets, such as standalone headsets that include an on-board processor, memory, such as the Apple Vision Pro, Vive Focus, Meta Quest 3, or Oculus Quest. Virtual reality headsets may include headsets that connect to a game console or computer such as the HTC Vive, Oculus Rift, or PlayStation VR. Other VR devices may include those that incorporate smartphones or similar devices such as Samsung Gear VR. In one example, the spatial computing device 40 includes a virtual reality arcade.

The spatial computing device 40 may include various sensors for sensing user movement, surrounding environment, or user interaction. Sensors may include motion sensors, touch interfaces, input devices or other gesture recognition devices to detect hand or other gestures, treadmills, body suits, eye-tracking devices, or cameras. The spatial computing device 40 may include various sensors configured for tracking, depth sensing, or creating interactive environments. The sensors may be configured to collect information regarding the environmental surroundings. The sensors may be configured to detect orientation or movement of the spatial computing device 40 or user. The sensors may include sensors for tracking or creating interactive environments by tracking movement and other user interactions. Sensors may include depth sensors, cameras, computer vision, accelerometers, gyroscopes, or other sensors. In some embodiments, the spatial computing device 40 includes user feedback devices such as haptic or audio feedback systems.

As introduced above, the spatial computing device 40 may include onboard processor and memory elements, which may include or be separate from memory 22 or processor 26, to process collected sensor data for detecting user interactions and surrounding environment. The interactions may be provided to the event vision application 24 to respond to the interaction according to the application rules and respond to the interaction by generating a new or updated rendering or other appropriate response to the interaction with respect to the extended reality experience. As note above, in various embodiments, the event vision application 24 may be executed by the XR processing unit 20 (which may be separate from or integrated with the spatial computing device 40) or both the XR processing unit 20 and spatial computing device 40 (e.g., a web application having server-side and client-side components). Thus, in some embodiments, the interactions are provided to the XR processing unit 20 for processing via the event vision application 24 and the XR processing unit 20 responds with updated 3D model or other digital content or display instructions to update the rendering in response to the interaction. In one embodiment, the XR processing unit 20 is configured to receive and process collected sensor data for detecting user interactions and surrounding environment and respond with updated 3D model or other digital content or display instructions that the spatial computing device 40 uses to update the rendering in response to the interaction.

In one embodiment, the spatial computing device 40, ER processing unit 20, or both execute spatial mapping with respect to the physical space around the user, e.g., information about the surrounding environment such as objects, surfaces, or spatial relationships thereof.

In one example, execution of the event vision application 32 is configured to enable projection based mixed or augmented reality. For example, the spatial computing device 40 may output digital content to overlay the physical environment, such as projecting or displaying a virtual or augmented reality element on to a surface in the real-world. Thus, the spatial computing device 40 may generate a projection or display digital content such as 2D windows, e.g., leaderboards, scorecards, video, 3D models 35, e.g., immersive models 54, shot trails 94, or other information directly onto physical objects or surfaces to create a mixed reality experience that blends virtual and real-world elements.

Execution of the event vision application 32 may be configured to enable rendering of augmented reality overlays such as 2D windows, e.g., leaderboards, scorecards, video, 3D models 35, e.g., immersive models 54, shot trails 94, or other information or virtual objects onto the real-world environment. This may enable users of the spatial computing device 40 to view and interact with both the overlay and real-world at the same time. Using mixed reality, execution of the event vision application 32 may be configured enable seamless blending of virtual and real-world environments to create a unified and interactive experience. The event vision application 32 may provide spatial mapping operations that enable virtual elements to interact with the real-world environment.

In one embodiment, operations of the XR processing unit 20 enables users of the spatial computing device 40 to utilize 2D windows 54 and 3D models 35, including immersive hole views, optimized for a spatial computing extended reality environment to follow live tournament golf event data unlike ever before.

The XR processing unit 20 may be configured to map and cause the spatial computing device 40 to display real-time shot data occurring in the physical world during live golf tournament events directly on the 3D models 35 and their corresponding hole and immersive hole views. In one embodiment, the XR processing unit 20 provides seamless navigation within 3D models 35 to immersive hole views 141 directly from hole views, which utilize the same source file to power both views.

The interactive experience may include golf tournament play in a live, which may include near real-time, environment. The extended reality experience with respect to live golf tournament play may include user directed aspects, e.g., users may interact to specify to particular players, player groups, holes, or location of on course from which to view play within the 3D model 35. In some embodiments, the experience may also include a replay experience that replays all or a portion of golf tournament play as if occurring live or in a user directed sequence. For example, users may interact with the extended reality environment to cause display of replays of previous shots taken earlier in the round, previous rounds, or previous tournaments within the extended reality environment. Replays may include user directed aspects. For example, users may select, e.g., via interaction with interfaces via hand gestures, voice, eye movement, hardware interface, movements, or other interaction, particular tournaments, tournament rounds, holes, player, player related statistics or play, player related detail, play related detail or statistics related to one or more tournaments, rounds, holes, or the like. Player related statistics or play may include user selected statistics such as longest drives, approach shots to within X feet of pin, putts longer than X feet. The user may specify the player related statistic or play for one or more particular tournaments, tournament rounds, holes, types of tournaments, types of holes (e.g., dogleg, blind tee shot, long par 5, trouble to left, raised green, par 3, 4, or 5). The user may request particular statistics, play, or shot replays related to environmental conditions during play such as temperature above or below X degrees or between X and Y degrees, rain, overcast, clear day, shots into wind, shots into side wind, wind assisted shots, or combination thereof. Thus, execution of the event vision application 24 may be configured to process user interactions and generate responses to the user with rendered content to selectively view replays, statistics, or live data.

In various embodiments, the system 10 includes an event vision application 24. The event vision application 24 may comprise an extended reality application configured to allow users to follow professional golf tournaments using spatial computing devices 40. Execution of the event vision application 24 may configure the spatial computing device to display tournament information such as leaderboards, scorecards and video in 2D windows. The event vision application 24 may be configure to access and process live and other event data from data sources 30 to generate content that when rendered by the spatial computing device 40 produces the interactive extended reality environment described herein. Additionally, 3D-rendered and immersive hole models may be employed to map shot trails from actual live shot data captured during the tournament. Execution of the event vision application 24 enables users to utilize 2D windows, 3D hole models for rending hole views and immersive hole views optimized for a spatial computing environment using a spatial computing device 40 to follow live tournaments unlike ever before.

The event vision application 24 includes instructions that when executed by the XR processing unit 20 provides the ability to map and the spatial computing device 40 to display real-time shot data occurring in the physical world during live events directly on 3D hole models within the corresponding immersive hole view within the event vision application. For example, mapping instructions with respect to real-time shot data may be generated via execution of the event vision application 24 and the spatial computing device 40 may render shot trails within 3D hole models using the shot data mapped to the 3D hole models. In operation, users may be enabled to seamlessly navigate to immersive hole views directly from a 3D hole model, which utilize the same source file to power both views. Execution of the event vision application 24 may include receiving live tournament scoring, such as live shot data. The event vision application 24 may be configured to interpret and display the shot data in a shot trail. A shot trail is a visual representation of the flight path taken by the golf ball. A shot trail may include a line that connects that starting point of the ball to the final location it stopped on the hole. Each shot a player takes on the hole may be displayed in this way until their golf ball reaches the hole. The shot trail may also represent other ball flight parameters such as the apex the golf ball reached. When multiple shot trails are displayed, each shot trail may be associated with the player that hit the shot using a visual indicator, such as color coordination to differentiate the shot trails of one player from those of other players. The event vision application 24 may be configured with historical and other event related data for incorporation into displays. For example, the event vision application 24 may be configured to request or otherwise receive, e.g., the event vision application 25 may configure the XR processing unit 20 to request or otherwise receive, event related data that is processed and incorporated into displays according to operation of the event vision application 24. In one instance, shot trail display and live tournament scoring data may be powered by a shot tracking system, such as PGA TOUR's ShotLink®, and made available to the event vision application 24. In one example, shot, shot trail display, and other live tournament scoring data is made available to the event vision application 24 using a cloud computing services such as an AWS infrastructure. In one embodiment, 3D hole models use universal scene description zip files hosted on a cloud computing services such as AWS. The data used for rendering or inclusion in the interactive extended reality environment may include scoring updates. The data used may also include one or more of group or player locations, tournament leaderboards, cutlines, standings, player rankings, or informative graphics with respect to play such as shot location graphics on particular holes for shots of multiple players, average strokes for players on holes, shot locations of players on holes corresponding hole score for those shots, obstruction analysis, hole analysis, hole flyovers, or course topography (e.g., green slopes or elevations).

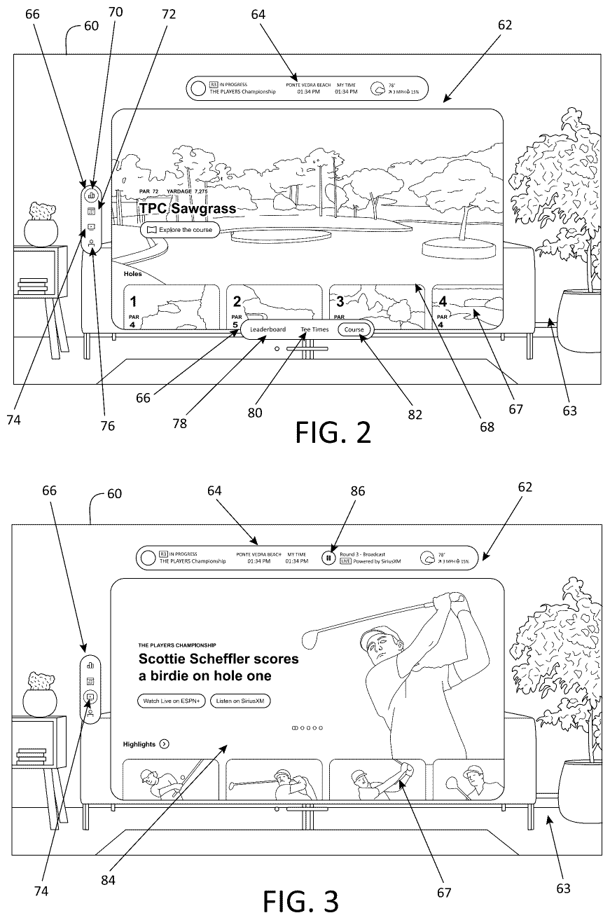

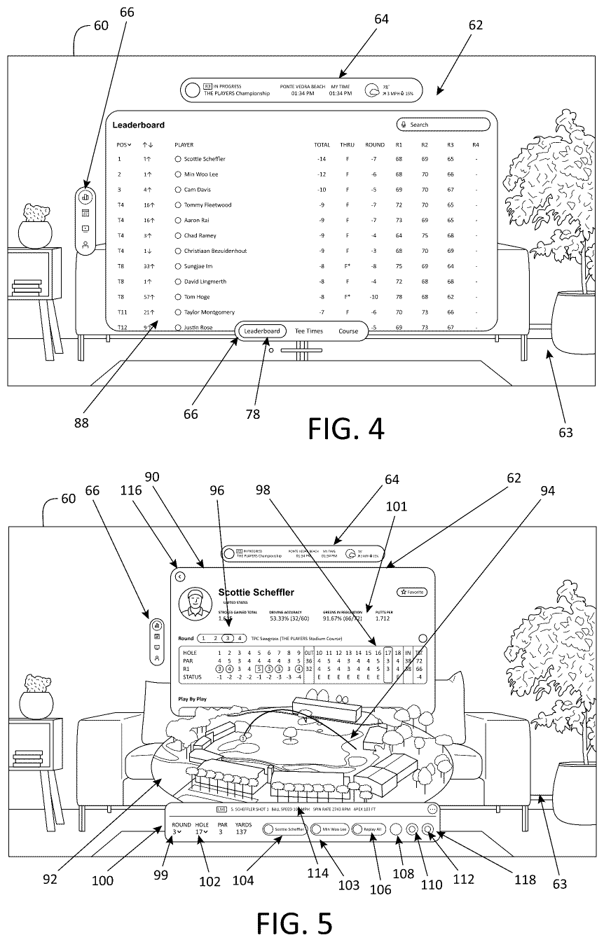

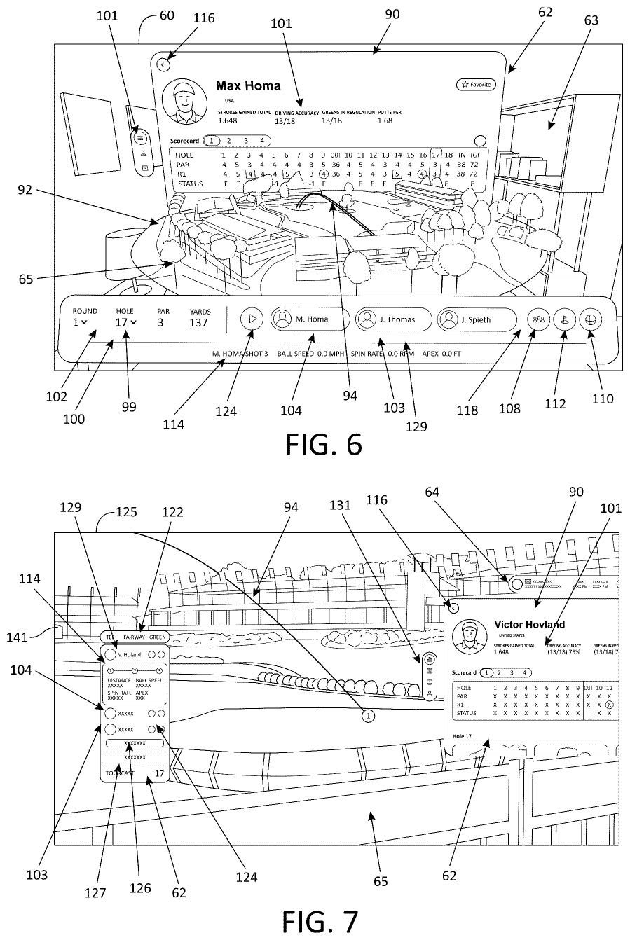

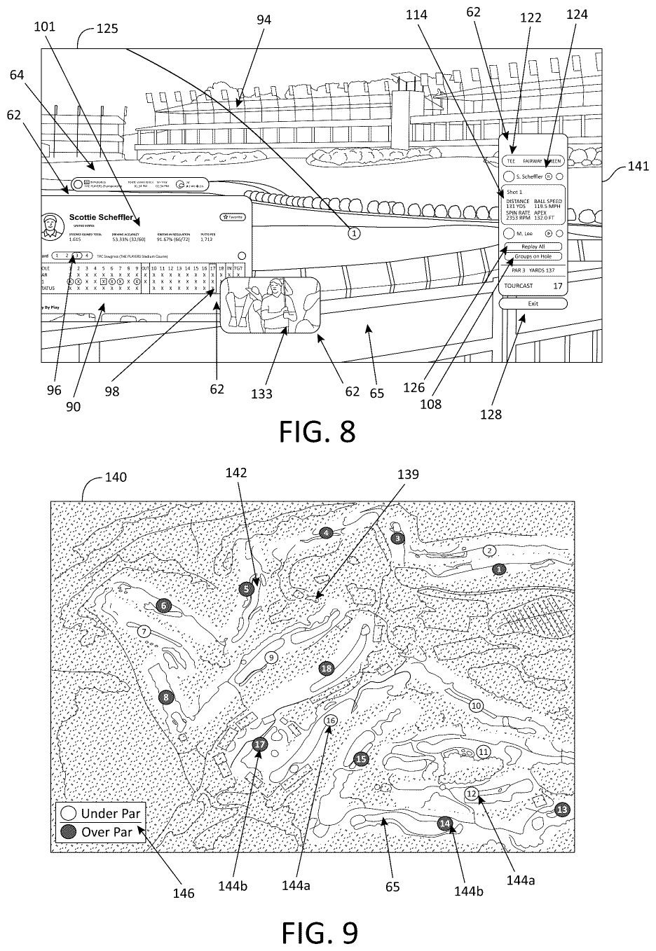

With reference to FIGS. 2-8, and as introduced above, the XR processing unit 20 may be configured with the event vision application 24. Execution of the event vision application 24 may be used to cause a special computing device 40 to render interactive extended reality views of a golf tournament and play. In some embodiments, the event vision application 24 may be configured to cause the spatial computing device 40 to overlay 2D windows 62 over a surrounding physical environment 63, e.g., on a surface, object, or otherwise, or onto a graphical rendering 65, which may include a 3D rendering. In various embodiments, the event vision application 24 is configured to cause the spatial computing device 40 via operation of the event vision application 24 to modify the 2D widow 62 representation, e.g., move, place, scale, or combination thereof, within the extended reality environment presented by the spatial computing device 40. This may be accomplished based on the analysis of collected sensor data with respect to the surrounding environment the 2D window 62 is to be projected on, the graphical rendering 65 and aspects thereof that the 2D window 62 is to overlay, or combination thereof. In various embodiments, the event vision application 24 is configured to cause the spatial computing device 40 to render one or more interactive 2D window 62 views selected from a course information panel view 68 (FIG. 2), an information panel view 64 (FIG. 2), a video panel view 84 (FIG. 3), a leaderboard view 88 (FIG. 4), a scorecard panel view 90 (see, e.g., FIG. 5), a shot panel view 100 (see, e.g., FIG. 5), a group panel view 129 (see, e.g., FIG. 6), a schedule and tournament details panel view, a current player rankings view (e.g., current PGA TOUR rankings), a video panel view 133 (FIG. 8), other panel views described herein, or combination thereof.

With particular reference to FIG. 2, the event vision application 24 may be configured to cause the spatial computing device 40 to render an extended reality view 60 comprising a 2D window view 62. The 2D window view 62 is projected onto or overlaying the physical environment 63 surrounding the user to provide an augmented or mixed reality experience. In other embodiments, the 2D window view may be provided within a virtual reality environment. The 2D window view 62 comprises a course view panel 68. The course view panel 68 is configured to provide interactive viewing of information regarding the course on which the event takes place. The information may be fed, e.g., via data sources, to the XR processing unit for implementation into the generated views and other features provided by the event vision application. As shown, the course view panel 68 provides information regarding TPC Sawgrass. The user may interact with the course view panel 68 to view the par rating and course yardage. The course view panel 68 includes sub-windows 67 for the holes that the user may interact with to view more information about the hole of the course. The hole information may include hole yardage, par rating, playing tips, flyovers, history, historical player performance on the holes or other statistics, or other information regarding the hole.

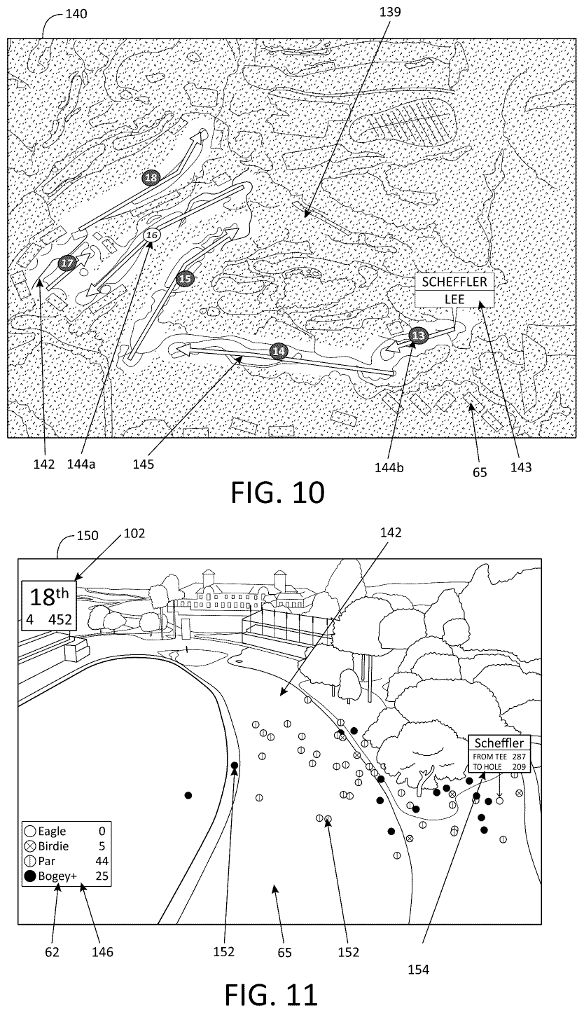

In some embodiments, a user may select hole views via interaction with the course view panel 68 to view live scoring information about each hole that makes up the tournament. As described in more detail below with respect to FIGS. 9-11, the live scoring information may include current play on the hole, course views representing group location and remaining holes (e.g., FIG. 9), current performance of the tournament competitors on the hole (e.g., FIG. 10), shot locations, such as scatter plots (e.g., FIG. 11), or other course information. An information panel view 64 is provided that includes tournament status including the current round and status of play, tournament location, current time at the course, and current weather data, which includes current temperature, cloud cover, wind speed and direction, and precipitation chance.

The graphical rendering 65 may also include a navigation interface 66 including navigation buttons that a user may interface to cause the spatial computing device 40 via the event vision application 24, which includes operations of the ER processing unit 20, to render available event data in desired views. As shown, the navigation buttons include a tournament button 70 that the user may interface to cause the spatial computing device 40 via operation of the event vision application 24 to provide another navigation interface 66 including a leaderboard button 78 with which the user may interface to cause the spatial computing device 40 via operation of the event vision application 24 to render an interactive current leaderboard panel view 88 (see, e.g., FIG. 4) for the tournament that displays the current scoring information from the tournament and allows the user to interact with the listed players and scores to navigate to player scorecards panel views 90 (see, e.g., FIG. 5), a tee times button 80 that the user may interface to cause the spatial computing device 40 via operation of the event vision application 24 to render an interactive tee time panel view (not shown) that the user may view and select groups to follow or set notifications of progress, and a course information button 82 that the user may interface to cause the event vision application to render the interactive course information panel view 68.

When viewing a player scorecard, interactive elements may be provided for user interaction to select a round and hole to cause the spatial computing device 40 via operation of the event vision application 24 to render a 3D hole model 92 of the hole (see, e.g., FIG. 5) that the user may further interface to view the player or player group's live or past performance on the hole, including viewing shot trails 94 of each shot, or directly toggle to an immersion mode 125 of the 3D model to view the same in an immersive hole view 141 (see, e.g., FIGS. 7 & 8). For example, the scorecard panel view 90 displays the scorecard of the specific player and allows the user to interface with the scorecard rendering to view live, current round, or previous round play in a hole view 92, which may include an immersion mode 125 (see, e.g., FIGS. 7 & 8). In some embodiments, the user may interact with a player scorecard to view a player profile of the player. The event vision application 24 may be configured to integrate player profile data into the extended reality environment. Player profiles may be stored in the information library 36 and provided on demand to the XR processing unit 20 or may be stored by the XR processing unit 20 locally for all or a portion of a tournament or longer. Player profiles may include information about all competing players, all players currently eligible to play, or the like. In a professional golf use case, player profiles may be available for incorporation into the extended reality environment for each player currently on the PGA TOUR. As described above, execution of the event vision application 24 may be configured to integrate statistics and visualizations into the extended reality environment. The statistics may include information about each player's performance in key event data points. For example, in a golf use case, the event data points may include one or more of driving distance, strokes gained, greens in regulation, average putts, average putts when player hits the green in regulation, or other event data points. The visualizations may include those shown or described herein, such as event data points integrated into and displayed in tables or graphical visualizations to aid the user in interpretation of the event data points.

The navigation interface 66 may also include a schedule button 72 that the user may interface to cause the spatial computing device 40 via operation of the event vision application 24 to render a schedule panel view (not shown) that includes tournament details of upcoming and competed tournaments chronologically. In one embodiment, interfacing with the navigation interface may cause the spatial computing device 40 via operation of the event vision application 24 to render a championship, league, or season ranking, such as the FedExCup, to view current player rankings (not shown). Such a panel view may similarly allow users to select listed players to view scorecards and performances during previous and current tournaments. The navigation interface 66 may also include a video button 74 that the user may interface to cause the spatial computing device 40 via operation of the event vision application 24 to render a video panel view 84 (FIG. 3) that includes tournament videos and highlights. The navigation interface 66 may also include a player or group button that the user may interface to cause the event vision application 24 to render a list of players or groups that the user may select to view scorecards in a 3D course model view or hole view 92 as described above and elsewhere herein.

With particular reference to FIG. 3, the event vision application 24 may be configured to enable the spatial computing device 40 to render an extended reality rendering 60 comprising an interactive 2D window 62 overlaying a physical environment 63 comprising a video panel view 84. The video panel view 84 may include a navigation interface 66 as described above with respect to FIG. 2. The navigation interface 66 includes a video button 74 that the user may interface to cause the spatial computing device 40 via operation of the event vision application 24 to render the video panel view 84 that includes tournament video and highlights, provided in sub-windows 67 in the illustrated example. For example, available video may include highlights, video of players taking shots on holes, or other produced videos. As described above, video data may be stored in a video library 38 (FIG. 1) and available on demand or pushed to the event vision application 24 for local storage for all or a portion of the tournament or longer. In some embodiments, the user may interface with the video view panel 84 to view play, highlights, or both from previous tournaments. The video panel view 84 may include an information panel view 64, which may also be as described above with respect to FIG. 2. The information panel view 64 may additionally or alternatively include media play button 86 that the user may interface to play or pause live video or audio broadcasts selectable in the video view panel 84.

With particular reference to FIG. 4, the event vision application 24 may be configured enable the spatial computing device 40 to render an extended reality rendering 60 comprising an interactive 2D window 62 overlaying a physical environment 63 comprising an interactive current leaderboard panel view 88. The leaderboard panel view 88 may include a navigation interface 66 as described above with respect to FIG. 2. In other provided views, the user may interface with the navigation interface 66 to select the leaderboard button 78 to cause the spatial computing device 40 via operation of the event vision application 24 to render the interactive current leaderboard panel view 88 for the tournament. The leaderboard panel view 88 displays the current scoring information from the tournament for the competing players and allows the user to interact with the listed players and scores to navigate to player scorecards panel views 90. In some embodiments, a user may select a hole of a round of a player to be transported to a 3D hole view 92 corresponding to the selected hole and round including the player scorecard. The user may view play of the player or player's group on the hole including shot trail 94 renderings of shots. The user may seamlessly toggle to an immersive mode 125 with respect to the 3D hole view 92 from the 3D hole view 92 to view an immersive hole view 141 (see, e.g., FIGS. 7 & 8) . . . . The leaderboard view panel 88 may also include an information view panel, which may be similar to that described above with respect to FIG. 2.

FIGS. 5-8 depict hole views 92 and an immersive hole view 141 in immersion mode 125 (FIGS. 7 & 8) of 3D hole models. The event vision application 24 may be configured to enable direct entry into the immersion mode 125 of the 3D hole model that renders the 3D hole model in a view of the hole in a scale corresponding to the human experience to provide an immersive extended reality experience as if the user is standing on the hole or surrounding area in the physical world. Shot trails 94 may be rendered in the 3D hole model as described herein, such as utilizing actual distance and apex information collected from the real-world and translated to the 3D space of the 3D hole model in a scale and alignment with the 3D hole model that is consistent with the actual real-world shot on the course. Shot trails 94 may be rendered utilizing actual distance, starting and ending coordinates, and apex information captured from the course by sensors of a tracking network. In the immersion mode 125 immersive scale views from various perspectives may be available. For example, users may be able to navigate to multiple locations of a hole to view the hole from multiple locations to gain different perspectives of the layout and view shots from multiple angles. Shot trails 94 may be rendered in real-time for players currently playing a modeled hole. Users may also interface with the operations of the event vision application 24 to initiate and view replays of previous shots taken earlier in a round or in previous rounds. Windows may be dynamically overlaid within the various views and include key information regarding shots. In some embodiments, shot distance, apex, ball speed, or combination thereof may be displayed for each shot to provide context alongside the shot trail 94. In one embodiment, the event vision application 24 supports dynamic loading of 3D models to be able to feature different holes from different tournaments on demand throughout a tournament season.

With particular reference to FIG. 5, the event vision application 24 may be configured to render an extended reality rendering 60 comprising an interactive 2D window 62 overlaying a physical environment 63 comprising an interactive scorecard panel view 90. The scorecard panel view 90 is provided as a backdrop to a 3D hole view 92 rendering of a selected hole of a round. For example, the scorecard panel view 90 includes selectable round buttons 96 and hole buttons 98 that the user may interface to select a hole from which the 3D hole view 92 and associated play of the player or player group is to be rendered by overlaying onto the physical environment 63. Additionally or alternatively, the shot panel 100 may be rendered such that it may be projected over the physical environment 63 and may or may not overlay the 3D hole view 92.

The shot panel 100 may include a round ID 99 and a hole ID 102 that identify the round and hole to which the view corresponds. In the illustrated embodiment, the round ID 99 and hole ID 102 include interactive dropdown features to allow a user to select a desired round and hole to be rendered in the hole view 92. The shot panel 100 may also include a group member interface 103 including player identifiers 104 representing each player in the group in which play is being depicted in the hole view 92. In some embodiments, the player identifiers 104 include buttons in which the user may interface to select a player in which shots are to be played for the hole. The group member interface 103 may also include a replay button 106. A user may interface with the replay button 106 to replay shots on the hole. When shots are replayed, the shots may be executed in the hole view 92 in a time period that is accelerated compared to that of the shots on the hole during live play.

The shot panel 100 may include a view navigation interface 118 including one or more view navigation buttons. As shown, the view navigation interface 118 includes a live play button 108 that a user may interface to toggle to live play on the hole or alternatively live play for the group. The view navigation interface 118 may also include a view manipulation interface button 110. A user may interface with the view manipulation button 110 to change the orientation or direction the hole view 92 is rendered. For example, the user may interface with the view manipulation button 110 to rotate the hole view 92 to change the perspective or viewing angle of the user. The view navigation interface 118 may also include an manipulation mode button 112. A user may interface with the immersion mode button 112 to toggle to immersion mode 125. Toggling to immersion mode 125 may be direct such that the 3D hole model used for the 3D hole view 92 is the same as is used to provide the immersion mode 125. For example, toggling to immersion mode 125 from the 3D hole view 92 provides a continuous transitions from the perspective of the 3D hole view 92 to the scale and a perspective of an immersive hole view 141 of the immersion mode 125, which may be referred to as transporting the user between views.

The shot panel 100 may also display shot data 114 corresponding to the current or most recent shot depicted in the hole view 92. In the view illustrated, the shot data includes identification of the player taking the shot, the shot number on the hole, and one or more shot parameters detected by oncourse sensors, which in this example include ball speed, spin rate, and apex. The shot panel 100 may also include hole information such as par value and yardage from tee to pin.

The event vision application 24 may be configured to map shot trails 94 to the 3D hole model using real-world coordinates as described herein to accurately render the shot trails 94 relative to the 3D hole model for display in the hole view 92 and immersion views 141 in immersion mode 125. As introduced above, shot trails 94 may include visual identifiers corresponding to the player hitting the shot, stroke number, or both. For example, a shot trail 94 may be color coded to be depicted as a particular color, such as yellow or another color, shot trail 94. The respective color code may be indicated in the group member interface 103. For example, player identifiers 103 may be marked with the corresponding color applied to their shot trails 94. In the illustrated example, a shot number is also associated with the displayed shot trail 94.

In the hole view 92, the scorecard may display player statistics 101 for the tournament or a preceding time period. As shown in FIG. 5, the scorecard includes player statistics 101 for the tournament comprising one or more of strokes gained total, driving accuracy, greens in regulation, or putts per green in regulation. The illustrated view may also include a navigation interface 66, an information panel 64, or both, which may be similar to that described above with respect to FIG. 2. The scorecard panel view 90 may also include a back button 116 to return the view to a leaderboard view, such as that shown in FIG. 4, or another view from which the user navigated to the hole view 92.

FIG. 6 depicts a hole view 92 including a scorecard panel view 90 and a shot panel 100. The view is similar to that depicted in FIG. 5 but provided in a different arrangement resulting from spatial mapping of the graphic renderings 65 to the physical environment 63. The hole view 92 is depicted for the 17^{th} hole of the first round of the tournament. Two partially opaque 2D widows 62 are overlaid onto the physical background 63. The scorecard panel view 90 is depicted as being positioned behind or partially obscured by the 3D hole model rendered in the hole view 92. The scorecard panel view 90 is that of the current player of the group having just taken a shot.

The user may interact with the scorecard to select a round and hole to view results or a replay of the hole for the player, the player group, or both. The shot panel 100 depicts the round ID 99, hole ID 102, par value, and hole yardage. The selected group includes 3 players, each is identified in the group member interface portion 103 of the shot panel 100. In some embodiments, a user may interface with the player identifiers 104 in the group member interface portion 103 to select one or more players to cause the spatial computing device 40 via operation of the event vision application 24 to render a replay of shots on the hole. To replay the hole, the user may interact with a shot play control button 124, e.g., by hand gesture, eye movement, voice or other suitable interaction, to allow the user control live or replay shots on the hole. For example, the user may interface with the shot play control button 124 to play and pause display or shot trails 94 in the hole view 92. The current shot corresponds to a third shot and shot trails 94 of the previous shots of the three players in the group have been mapped to the 3D hole model and rendered therein for display within the hole view 92. The shot trails 94 are identified by separate colors that code to the players in the group provided in the group member interface 103. For example, a shot trail 94 for a first player in a group may be color coded to be depicted as a particular color, such as yellow or another color, shot trail 94. A shot trail 94 for a second player in the group may be color coded to be depicted in a different color, such as red. And a shot trail 94 for a third player in the group may be color coded a different color, such as blue. A color code key may be provided to enable visual linking of the shot trail to the player. For example, the group member interface 103 may include an indication of the color code for the players in the group, such as by associating the color assigned to each player (e.g., player name in color text, color outline around a player's name, or the like). Thus, the event vision application 24 may provide views of 3D hole models including player groups or groups of selected players wherein shot trails of the players on a particular hole are displayed to enable users to visualize different ball flights of the players in a single view. These unique views provide users the opportunity to analyze how different players played the hole.

In some embodiments, a user may identify one or more of the players in the group to replay the hole by interacting with the player identifiers 104 to select the players and then interact with the play button to initiate or pause the replay. Interaction with a player identifier 104 may additionally or alternatively cause rendering of the scorecard of the player. During replay of the hole, the scorecard of the player associated with a current shot may be displayed. Information regarding the player may also be provided, such as player stats 101 comprising one or more of strokes gained total, driving accuracy, greens in regulation, or putts per green in regulation. Information regarding the shot may be provided. Such information comprising shot data 114 may be provided in one or both of the scorecard panel view 90 or shot panel 100. As shown, current player and shot number (i.e., 3) are displayed in the shot panel 100. Additional shot information may be provided such as one or more of ball speed, spin rate, apex, distance of shot, distance to the pin, swing speed, smash factor, or the like. This information may be provided in the shot panel 100, scorecard panel view 90, or combination thereof. A view navigation interface 118 may be provided to aid the user in navigating the extended reality environment. A live play button 108 may be provided that when interacted with causes the hole model view 92 to go live to the current group on the hole wherein the scorecard panel view 90 and shot panel 100 change to the current player having taken a shot and the group currently on the hole, respectively. An immersion button 112 is provided that when interacted with causes the event vision application 24 toggle to immersion mode 125 for immersive hole views 141. For example, interacting with the immersion button 112 may take cause the user to be presented with a human scaled, 360° rendering of the 3D hole model for an immersive extended reality experience. A view manipulation button 110 may be provided to manipulate the displayed angle or orientation of the hole view 92. For instance, a user may rotate the hole view 92 to change the perspective of the user's view.

While the hole views 92 and scorecard panel views 90 in FIGS. 5 & 6 are rendered in an augmented or mixed reality environment, in other embodiments hole views 92 and scorecard panel views 90 may be provided in a virtual reality or immersive environment.

FIG. 7 depicts an immersive hole view 141 in immersion mode 125 of a 3D hole model rendering. The immersive hole view 141 comprises an immersive hole view 141 of the green. The immersive hole view 141 also includes an interactive scorecard panel view 90. The immersive hole view 141 includes a live shot trail 94 mapped to the 3D hole model and rendered therein. The shot trail 94 is coded for identification of the player the shot trail 94 corresponds to as provided in a group panel view 129 overlaid on the graphic rendering 63 of 3D hole model, which includes color coding in the example shown. An immersion mode navigation interface 122 is provided that includes selectable buttons to interface with the user with available immersive hole views 141 to provide navigation options to multiple locations of a hole that provide immersive views of the hole from multiple locations and gain different perspectives of the layout and view shots from multiple angles. In the example shown, the immersion mode navigation interface 122 includes navigation buttons for tee box, fairway, and green to provide immersive hole views 141 of the same. In some embodiments, the user may navigate to other locations within the different locations utilized additional buttons or via interaction with the environment, such as with voice, motion, or tactile interactions.

A 2D window 62 is overlaid on the immersive hole view 141 and is configured for user interaction and information delivery. Shot data 114 corresponding to a current shot is provided under the player identifier 104 corresponding to the shot. A shot line depicting three numbered shots is provided in the shot data 114 with the circle including the number “1” being filled to identify the shot as the first shot. The shot trail 94 is also identified with the number “1” at its final resting position. Shot data is also provided including distance, ball speed, spin rate, and apex. Additional, fewer, or other shot related data may be provided in other embodiments. Each player identifier 104 includes a shot play control button 124 that a user may interface to play or pause rendering of live or replayed shots. A hole replay button 126 may be provided for the user to interface to initiate replay of shots on the hole for the player or group. Hole data 127 such as yardage distance from tee to pin, par value, or both may be displayed. A drop down button or other interface may also be provided next to each player identifier 104 to allow a user to selectively show or hide shot data 114 for the player. The 2D window 62 may also include a hole ID corresponding to the current hole. In one embodiment, the 2D window or another window may include a link to another application, such as TOURCAST.

A scorecard panel view 90 is overlaid onto the immersive hole view 141 and corresponds to the player associated with the current shot. The scorecard panel view 90 may include player statistics 101 for the tournament, such as one or more of strokes gained total, driving accuracy, greens in regulation, or putts per green in regulation. A back button 116 may be provided that the user may interface to return to the hole view 92. An information panel 64 may be provided to provide general information regarding tournament conditions and other tournament statuses, such as those describe above with respect to FIG. 2. An immersion mode window selection interface 131 may be provided that includes various available features such as player search, video data associated with the player or group playing the hole, or settings to allow users to personalize the extended reality experience by defining actions, shortcuts, or selection of data to be including in 2D windows. In some embodiments, settings may be used to define a level of opaqueness of 2D windows or location of windows in one or more views.

FIG. 8 depicts an immersive hole view 141 similar to that described above but including a different configuration and location of 2D windows. In FIG. 8, the user has interacted with a video selection button or window to overlay a video window 133 displaying a video of the player taking the shot in sync with the rendering of the shot trail 94 mapped to the 3D hole model. An exit view button 128 is provided to allow the user to exit the view and return to the hole view 92. A live play button 108 is provided to allow users to cause the event vision application to render live play action on the hole. The scorecard panel view 90 includes selectable round buttons 96 and hole buttons 98 that the user may interface to select a hole from which the hole view 92 and associated play of the player or player group is to be rendered. Shot play control buttons 124 and an immersion view navigation interface 122 is provided in a similar manner as described with respect to FIG. 7.

With reference to FIG. 9-11, the event vision application 24 may be configured to enable rendering of various course views 140 or hole views 150. Course views 140 or hole views 150 may comprise 3D or 2D models of the course or hole thereof. In some embodiments, course views 140 may be broken down into smaller views including less than all holes to less than a full hole view 150 for ease of viewing. In one embodiment, course views 140 and hole views 150 may be accessed via the course information button 82 (FIG. 2). For instance, after interacting with the course information button 82, the event vision application 24 may provide various options related to viewing course information and live scoring information about the holes that make up the course of the tournament. The options may include views incorporating scoring of the field of players during the tournament, e.g., eagles, birdies, pars, bogeys, double bogeys or higher, or score average on each hole. The options may include views incorporating landing zones off tee, second shot, or into green of holes of the course. The options may include views incorporating average number of putts, average distance to hole on green, or first putt locations. The options may include views incorporating group or player locations on the course, group or player holes completed, yet to be completed, or both.

In some embodiments, the event vision application 24 is configured to enable the spatial computing device 40 adjust the angle, perceived distance, or both of the course view 140, e.g., via analysis of user interaction collected by one or more sensors of the spatial computing device 40. Thus, the user may be provided with multiple views of the course view 140 or a hole view 150 thereof. In various embodiments, a course view 140 or hole view 150 thereof may be presented in an immersive, 360° virtual reality environment. In one embodiments, a course view 140 or hole view hereof may be presented in an augmented or mixed reality environment. For instances, views 140, 150 may be projected onto or otherwise overlay a physical environment 63.

The course view 140 shown in FIG. 9 depicts the field's current scoring average relative to par thus far in the tournament. The course view 140 comprises a graphic rendering 65 of a 3D course model as viewed from an elevated perspective wherein the holes 142 are highlighted. The holes 142 are numbered and the hole numbers may be encircled by a color code depicting the field's current scoring average on each hole 142 relative to par. The color code is shown in a key panel 146 that overlays the 3D course model of the course view 140, wherein holes numbers encircled by gray 144a indicate an under par scoring average on the hole 142 and hole number encircled by black 144b indicate an over par scoring average on the hole 142. For example, the hole numbers for holes 12 and 16 are encircled by gray 144a, indicating that the field is averaging under par on these holes 142. In contrast, holes 14 and 17 are encircled by black 144b, indicating that the field is averaging over par on these holes 142.

The course view 140 shown in FIG. 10 includes a graphic rendering 65 of a 3D course model viewed from an elevated perspective. The course view 140 depicts holes 142 yet to be completed by a specific group 143. In the 3D course model rendered, the remaining holes 142 to be played are highlighted. Arrows 145 overlay the holes 142 to indicate the direction of play. The holes 142 are numbered and the hole numbers are encircled by a color code depicting the field's current scoring average on each hole 142 relative to par according to the key panel 146 described and shown with respect to FIG. 9, wherein holes numbers encircled by gray 144a indicate an under par scoring average on the hole 142 and hole number encircled by black 144b indicate an over par scoring average on the hole 142. For example, the hole number for hole 16 is the only hole number encircled by gray 144a, indicating that hole 16 is the only hole 142 of the highlighted holes 142 that the field is averaging under par. In contrast, all the remaining holes 140 include hole numbers encircled by black 144b, indicating that the field is averaging over par all such holes 140.

FIG. 11 provides a graphic rendering 65 of hole view 150, which may be a zoomed in close-up view of a hole 142 of 3D course model, wherein the additional holes 140 may be viewed together or separately to provide similar information for those holes 40. The example hole view 150 comprises a partial view of the hole 140 and is focused on a portion of the fairway and surround grounds that encompasses the current off-tee landing zone dispersion for competing players on the hole 140 during the tournament. The hole view 150 provides a scatter plot of off-tee shot locations of players during the tournament. The shot locations are depicted as objects 152 visually coded to provide information about the hole score of each player whose off-tee shot is depicted by the location of the objects 152 to provide the user information regarding the course and live scoring with respect to the holes 140 that make up the course 139 of the tournament. A 2D window 62 comprising a key panel 146 overlays the hole view 150 and provides color codes of the objects 152 corresponding to the eventual hole scores, including eagle, birdie, par, and bogey and up. The key panel 146 also includes a running count of each score category. A 2D window comprising an object label 154 is also shown that includes the name of the player associated with a shot location and the distance from the tee and hole. In some embodiments, user may interact with the objects 152 to reveal the player name corresponding to the location and the tee and hole distances. In one example, a user may select a player and hole and the event vision application 24 may provide data for the spatial computing device 40 to render a scatter plot similar to that shown and include the an object label 154 identifying the player's shot. A hole ID 102 may also be included to identify the hole shown in the hole view 150. Additional hole data may also be included, such as par value and yardage.

It is to be appreciated that additional or different information, interfaces, or combination thereof may be provided in other embodiments. Similarly, such information, interfaces, or combination thereof may be organized at different locations, in different panels, or combination thereof without departing from this disclosure. While various interfaces may be referred to herein generically as buttons, those have skill in art will appreciate upon reading the present disclosure that the buttons are not limited to traditional buttons that may be actuated, clicked, or selected with a graphic pointer or cursor. Indeed, the buttons may indicate selection or navigation locations triggered by user interaction such as voice, touch, or user movement, e.g., hand, eye, or head.

In one example, shot trail displays and live tournament scoring are powered by a live data source 32 (FIG. 1) comprising PGA TOUR's ShotLink system and made available to the event vision application 24 using a cloud computing infrastructure, such as AWS. In this or another example, live scoring data and updates thereof may be expediently delivered to the XR processing unit 20 from the live data source 32 encrypted. In an above or another embodiment, 3D models may be provided in USDZ files host on a cloud computing infrastructure.

In various embodiments, one or more of the 3D models employed by the event vision application 24 may be generated from detailed map data that comprise a measured surface model specifying ground and object topography of coordinates of a golf course property. The surface model may comprise a 3D coordinate model, which may comprise a digital surface model measured by LiDAR, photogrammetry, radar, and the like. For example, 3D models may be generated and mapped using map data of a course, which may include a 3D map of the course. The course map data may be defined within a coordinate system such that locations or points in the course map are associated with coordinates, which may be referred as a coordinate map. Map data may include cloud point data collected from LIDAR and photogrammetry. Map data may also include location of monuments around the course having known coordinates and spatial relationships, such irrigation system coordinate data. To generate the course map, ground control markers may be placed on the course at known locations and recorded. The location data for the ground control markers may then be used as reference points for generating the course map from the point cloud data. Coordinates of the ground control markers may be used to key the point cloud data to a coordinate system. 3D maps and 3D hole models may be generated using point cloud processing hardware and software, which may receive map data for the course, extract the point cloud data and the ground control marker location data, and process the point cloud data and the ground control marker location data to generate the 3D models, such as 3D hole models.

The course map may include a measured surface model including surface features modeled in various levels of detail in the course map. For example, the course map may include surface identification and properties such as surface contours, angles, relative heights of surfaces, or both. In a further example, detailed surface properties such as material, firmness, or the like may be incorporated into the course map or provided separately. In one embodiment, surface features may be specified down to an inch or less in the course map. Increased level of surface detail included in the course map may be used to enhance the extended reality renderings of the 3D hole or course models. The course map may include manmade objects in addition to natural terrain and vegetation of the property. For example, surfaces of objects on the property such as camera towers or grandstands may be modeled to include detailed 3D structures. In one example, trees may be mapped in detail beyond canopy dimensions, e.g., to include limbs and leaf locations, or a bridge may be mapped to include railings and posts.

As introduced above with respect to FIG. 1, the system 10 may include or receive coordinate data from live data source 32. Coordinate data corresponding to historical shots or other object locations may also be stored and provided to the XR processing unit 20 by the stats library 37. The live data source 32 may include or be configured to collect coordinate data corresponding to ball locations or other object locations. For example, the live data source 32 may include or receive coordinate data from a tracking system comprising one or more coordinate sources that monitor location and movement of balls and other objects, such as players, during a sport event, such as a golf tournament, and transmit the coordinates to the XR processing unit 20 for use by the event vision application 24 when mapping the coordinates to 3D models, such as 3D course models, 3D hole models, or both.

Coordinate sources may include camera coordinate sources comprising one or more cameras that may be positioned around a golf course to track movement and identify distance using an associated laser or rangefinder or via optical calculations. For example, each camera may calculate the distance a ball or other object of known size by comparing the optically captured size of the object to that of the known size of the object. Further determination of the angle of the camera may be used to plot the location of the object at the distance and angle from the camera relative to a map of the region around the camera to identify coordinates corresponding to the location. Location determination may be enhanced utilizing multiple cameras, e.g., to triangulate or otherwise determine location of a ball or other object. In one example, an optical map of a region of the course from a view of a fixed camera may be utilized by a camera to determine location of objects relative to known locations within the mapped region. For example, by comparing an image captured of an object to surrounding features in the image of known location, the approximate location of the object may be determined. Optical calculations such as those described above may be used to determine distance to enhance the accuracy of the location determination.

In one embodiment, cameras are calibrated to a coordinate map of the course. The coordinate map may be a 3D point cloud map that the field of view of the camera is overlaid to determine location of balls. For example, the camera view and the 3D point cloud, e.g., generated by LiDAR, view align such that when an operator, laser rangefinder, or system component, e.g., tracking software utilizing object tracking, identification, or recognition, identify a location in the camera view, the coordinate or point in the 3D point cloud identifies the location. The coordinate may also be translated into another coordinate system prior to or during spatial mapping for rendering the live coordinates within the coordinate space of the 3D models, such as the 3D hole models to generate the interactive extended reality experience. Other sensors, such as radar may similarly be calibrated. In one example, the coordinate map is collected using LiDAR; however, other mapping techniques may be used.

Camera coordinate sources may be configured for optical recognition to identify balls or other objects. In one embodiment, camera coordinate sources may utilize optical recognition/augmented reality (AR) to balls. Cameras may typically be located at known locations, but in some instances one or more cameras may be utilized in a mobile environment, e.g., utilizing RTK base stations or network, such as RTK based GPS, or other location methodologies with respect to determining the location of the camera, such as those described herein with respect to laser rangefinders. In some embodiments, camera coordinate sources may be used to identify motion and objects and a laser or rangefinder associated with a camera may target such objects to determine distance of the object from the camera. Combining camera view angle with distance, the location of the object may be determined. In some embodiments, topology of the region may be mapped or determined and added to the distance calculations. Coordinates collected by camera coordinate sources may include a “shot from” coordinate, a final resting position coordinate, or both. In some instances, a ball may enter the field of view of a camera while in flight and the starting point of tracking by the camera is the first place the ball entered the field of view. Camera coordinate sources may be operated by a human or fully or partially automated or autonomous robot. Cameras may operate in the visual spectrum and/or optical spectrum to include one or more of the visual spectrum, ultraviolet spectrum, or infrared spectrum.

Coordinate sources may include radar coordinate sources implemented to track balls, which may include location, velocity, trajectory, acceleration, or other parameters. Radar may be used to track balls in the air. Multiple radar devices may be positioned around the course to collect coordinates. Radar devices may typically be located at known locations, but in some instances one or more radar devices may be utilized in a mobile environment, e.g., utilizing RTK base stations or network, such as RTK based GPS, or other location methodologies, such as those described herein with respect to the laser rangefinder coordinate source. Radar coordinate sources may provide coordinates with respect to a “shot from” location, i.e., where a ball flight initiated, and coordinates of an impact location. Radar coordinate sources may be operated by a human or fully or partially automated or autonomous robot.

Coordinate sources may include laser coordinate sources positioned around the golf course to measure distance of balls and generate coordinates of the ball. Lasers may provide coordinates with respect to a from location, a final resting position, or both. Laser devices may be operated by a human or a fully or partially automated or autonomous robot. Laser devices may typically be located at known locations, but in some instances one or more laser devices may be utilized in a mobile environment, e.g., utilizing RTK base stations or network, such as RTK based GPS, or other location methodologies with respect to the laser device, such as those described herein with respect to laser rangefinder coordinate sources.

In various embodiments, coordinate sources may include a prediction generator that utilizes ball flight data such as location, velocity, trajectory, acceleration, or other parameters collected by radar, lasers, cameras, or combination thereof to predict a final resting position of the ball. The prediction generator may be configured to predict ball flight, impact coordinates, bounce, roll, final resting position, or combination thereof as described in U.S. patent application Ser. No. 18/238,234, filed Aug. 25, 2023, the contents of which are hereby incorporated by reference. The prediction generator may include a processor and memory storing instructions that when executed by the processor perform the operations of the prediction generator. The prediction generator may include or access a database including one or both of course maps or location information with respect to radar, lasers, or cameras supplying flight parameters to identify locations, coordinates, ground characteristics, or combination thereof. In one embodiment, devices supplying ball flight parameters may transmit location information with flight parameters. In one example, the prediction generator takes ball flight parameters, such as those collected by radar coordinate sources, and applies AI to make an educated guess on final resting point. Location of the ball in flight may be determined relative to a map of the course and the location of the device measuring ball flight parameters. The coordinates may be accompanied by or associated with data elements such as a timestamp corresponding to the predicted time the ball came to rest at the predicted coordinate. Data elements may also include a geographic identifier. The geographic identifier may include a hole or other area of the golf course. The geographic identifier may be associated with the coordinate by the coordinate source, coordinate database, or coordinate processor. The geographic identifier may be determined by cross-referencing the coordinates with a coordinate map of the golf course, the sensor location corresponding to the coordinate source, the sensor location and its field of view, or by other suitable methodologies.

In some embodiments, coordinate sources include personnel sources that include personnel that collect coordinates and transmit the coordinates to the coordinate database 210. Examples of personnel sources include map interaction wherein personnel interact with digital maps or printed maps of a hole to identify a ball location relative to the map and transmit the coordinates to the coordinate database 210 via an electronic communication device. For example, personnel may indicate ball location on a touch screen of the electronic communication device displaying a digital map or enter ball coordinates into the electronic communication device determined by identifying the ball location on a grid or other coordinate map overlaying a map of the course.

Another example of a personnel source is a laser rangefinder coordinate source wherein personnel operate a laser rangefinder that when targeted to a ball generates a coordinate location of the ball. Laser rangefinder coordinate sources may be set up relative to the course at a known, stationary location such that the direction the laser is directed (e.g., using compass hardware such as one or more of a magnetometer, accelerometer, gyroscope, or mechanical position tracking) may be combined with the measured distance to obtain the coordinates of the ball. In another example, a laser rangefinder coordinate source may operate in a mobile environment, e.g., utilizing RTK base stations or network, such as RTK based GPS, or other location methodologies with respect to determining the location of the laser rangefinder, such as locating, positioning, and/or proximity technology. For example, in one configuration, laser rangefinders or an associated or other electronic communication device that receives laser measurements from the laser rangefinders, such as a computer including a processor and memory, is equipped with hardware, e.g., real-time kinematic GPS, compatible with a location service infrastructure for tracking the location, position, or both of the laser rangefinder when a distance measurement is made to identify coordinates of a targeted ball. The location services may include one or more of a global satellite constellation infrastructure or location network with respect to the golf course and may include radio receivers, transmitters, transceivers, antennas, UWB antennas, anchors, initiators, responders, cell towers, Wi-Fi access points, beacons, geobeacons, BLE gateways, or the like. In some embodiments, a location network including external location/signal networks that utilize short range or long range location technologies, which may include signals of opportunity. According to one embodiment, laser rangefinders or an associated or other device that receives laser measurements from the laser rangefinders includes GPS hardware to identify the coordinates of the laser rangefinder. This offers the ability to shoot a target location, e.g., ball, at a distance. Based on the GPS location, target angle compared to north (utilizing compass hardware), and the distance recorded from the ball location to the laser rangefinder, the coordinates of the ball location can be calculated. In some embodiments, mobile cameras or mobile LIDAR calibrated to the course map and employing location services or technologies such as GPS or GPS augmented with RTK base stations or network, such as RTK based GPS, or other location methodologies with respect to improved GPS location accuracy.

In one embodiment, a personnel coordinate source includes an electronic communication device similar to the map interaction coordinate source described above including a display screen that displays a map of the course for indicating or identifying the location of a ball relative to the map by interacting with the displayed map, e.g., by touching or plotting the location of the ball or viewing coordinates on the map and entering the coordinates. The electronic communication device may be sized and configured to be carried for handheld operation. The map may be a coordinate map such that indicating the ball location causes the corresponding coordinates to appear for further entry or automatically trigger collection of the coordinates. The electronic communication device may also include or operatively connect to a laser rangefinder that may be similar to that described with respect to the laser rangefinder coordinate source Personnel may be given an option of indicating the ball location via interaction with the map or by targeting the ball with the laser rangefinder.

In various embodiments, a method of spatial mapping live, real-world event coordinates to a 3D model, such as a 3D hole model, to render shot trails therein for providing an interactive extended reality experience includes generating and mapping the 3D hole models using known monument locations and coordinates on a golf course, such as irrigation system data, for each hole. Using the known monument location may be used to ensure the 3D hole models line up properly with the real-world coordinates.

An origin point may then be set for each hole to ensure shots line up on the 3D hole model. An offset move may then be set from real-world coordinates to move the 3D hole model back to the origin point. This keeps all original information intact.

The model may then be rotated on the origin to align with the known monument coordinates.

In configurations wherein the 3D axis orientation differs between received real-world coordinates and the 3D hole model coordinates, the model may be exported to the corresponding axis orientation. For example, if the real-world coordinates are defined in a Y up coordinate structure and the 3D hole model is defined in a Z up coordinate structure, the 3D hole model may be exported from Z up to Y up to conform with the defined axis orientation employed by the real-world coordinates. Exporting the 3D hole model may also include exporting it to a file. The file may be a USDZ file, for example. In one example, the 3D hole models may be transmitted to the event vision application 24. In a further example, the event vision application 24 may be configured to dynamically download the 3D hole models for the holes of the course being played in the tournament and loads the models into memory 22. When real-world coordinates, such as GPS or other coordinates mapped to another coordinate space are received by the event vision application 24 from the live data source 32 or stats library 37, the event vision application 24 reads the origin point and applies it to the shot trail code and then applies an offset back to 0, 0, 0 (origin) to line the shot trail with the 3D hole model. In one embodiment, a separate 3D model for the hole flag for the holes is generated and imported into the 3D hole models. As the location of hole flags are changed each round, this avoids having to modify each of the 3D hole models between every round. Thus, the real-world coordinates for the hole flag are obtained before each round and is mapped to the 3D hole model by reading the origin point, applying it to the shot trail code and then applying an offset back to 0, 0, 0 (origin). In one embodiment, the extended reality experience may be further fine-tuned. For example, the event vision application may provide an offset value for the flag and shot trails per the model to fine-tune the experience.

According to one method, a hole model is generated for each hole of the course as described above, e.g., the hole model may comprise a digital surface model measured by LiDAR, photogrammetry, radar, or other suitable technologies carried by remotely piloted, other aircraft, walking or robotic ground-based devices, or combination thereof. The hole model may be mapped using monuments having known locations. For example, hole models may be generated and mapped using on-course irrigation system data comprising known, real-world, coordinates of irrigation system components. By generating and mapping using known coordinates an spatial relationships in the real-world space being modeled, additional and specific accuracy may be continuously achieved. The monument data may be used to line up the model with the real-world coordinates.

With the model properly aligned with the real-world coordinates, the 3D coordinate space of the model may be synced relative to the real-world coordinates to ensure overlaid data representing real-world data within the real-world space of the hole lines up with the modeled space. For example, shot trail data processed by the event vision application 24 may include real-world coordinate data including starting location and ending location of a ball. Other data may include impact location, bounce, roll, or other ball or flight path coordinates. As explained in more detail herein, the event vision application 24 may use this data to generate shot trails within the rendered views representative of the ball flight relative to the course within the 3D hole model. This real-world coordinate data may be imported to the event vision application 24 and the event vision application 24 may then translate the real-world coordinates to the model coordinates. Alternatively, real-world coordinate data may be imported to the event vision application 24 translated to the model coordinates. In one configuration, an origin point is set for each hole. The origin point may be used to define the coordinate space values within the model. The origin point may generally be selected as any point on the respective hole. An offset move may then be set from real-world coordinates to move the model back to the origin. For example, a monument represented in the aligned model having a known real-world coordinate may be used to define an offset coordinate value from the origin.

If necessary, the model may also be rotated to ensure the model coordinate space is in proper orientation relative to the real-world coordinate space. For example, using multiple known points, e.g., monument coordinates such as irrigation system components, the model may be rotated on the origin to meet the real-world coordinates with the corresponding model coordinates.

Hole models may be transmitted, downloaded, or both to a data storage device accessibly by the app. For instance, data files including prepared models and supporting data may be downloaded or otherwise accessed by the event vision application 24. In one embodiment, a course overview model may be downloaded at launch of user interaction with a course and hole models may be dynamically downloaded to support user interaction with respective hole models. The data storage device may include local or remote storage with respect to the processor executing the event vision application 23.

When real-world coordinates, such as GPS or other coordinates mapped to another coordinate space, are received by the event vision application 24 from the live data source 32 or stats library 37, the event vision application 24 reads the origin point and applies it to the shot trail code and then applies an offset back to 0, 0, 0 (origin) to line the shot trail with the 3D hole model. In one embodiment, a separate 3D model for the hole flag for the holes is generated and imported into the 3D hole models. As the location of hole flags are changed each round, this avoids having to modify each of the 3D hole models between every round. Thus, the real-world coordinates for the hole flag are obtained before each round and is mapped to the 3D hole model by reading the origin point, applying it to the shot trail code and then applying an offset back to 0, 0, 0 (origin).

Visual appearance of the model may indicate that one or more displayed features should be adjusted. This may be present with respect to a 3D hole flag model or shot tails, such as starting point, flight path, impact point, landing location, or the like that are rendered at anomalous locations. Accordingly, the event vision application 24 may be configured to provide an offset value for the 3D hole flag model or shot trails per the model to fine tune the extended reality experience within the immersion environment. This offset may be applied to conform model space representation to the real-world. The offset value may be applied and shift the location of the flag, shot trails, or both in the model to new model coordinates. Anomalies in shot trails may be fine-tuned in a similar manner to shift renderings of shot trails to locations that better represent real-world locations within the model.

In one embodiment, a method of spatial mapping live, real-world event coordinates to a 3D model to render shot trails therein for providing an immersive extended reality experience includes mapping a 3D model of a hole of a golf course using monuments within a real-world space of the hole; dynamically downloading the 3D model to memory of a device that executes an event vision application or that is in data communication with the event vision application; and mapping, to the 3D model, real-world shot data from shots taken on the golf course during a golf tournament, wherein the real-world shot data includes real-world coordinates of ball flights of shots and the mapping includes mapping shot trails from the real-world coordinates of the ball flights using coordinates of the 3D model relative to the coordinates of the monuments such that the mapped shot trails are representative of real-world ball flight of the shots hit on the hole of the real-world golf course, and wherein the mapped shot trail is rendered by a spatial computing device to generate a display of the shot trail within the 3D model that provides an extended reality environment within which display of real-world events.

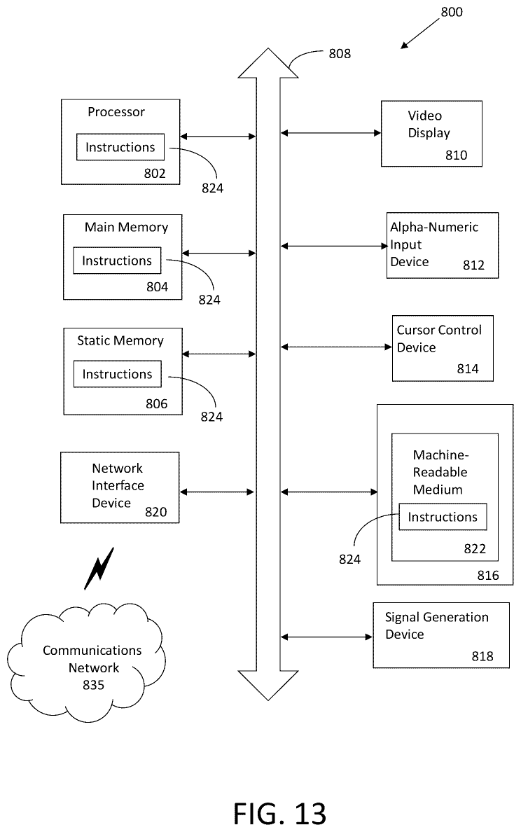

FIG. 13 illustrates a method 400 of spatial mapping live, real-world event coordinates to a 3D model, such as a 3D hole model, to render shot trails therein for providing an immersive extended reality experience. The method may include generating and mapping 3D models of holes of a real-world golf course using monuments within the real-world space of the holes being mapped 402. In one embodiment, the monuments have known coordinates and spatial relationships. In a further embodiment, the known coordinates are defined within a same coordinate space as real world coordinates that will be spatially mapped to the 3D models in the extended reality environment. The 3D models may be dynamically downloaded to memory of a device that executes the event vision application or that is in data communication with the event vision application 404. Dynamically downloading the 3D models is particularly beneficial when the event vision application is executed on a consumer device, particularly spatial computing devices, having limited resources. The shot trails may be mapped to the 3D models, wherein the shot trails are representative of real-world ball flights of balls in the real-world space the 3D models model, and wherein shot trails are mapped from real-world coordinates of the ball flights in the real-world space using coordinates of the 3D models relative to the coordinates of the monuments 406. The method may further include rendering shot trails in an extended reality environment 408. In some embodiments, the method may include fine-tuning the 3D models as described above.

In one embodiment, a method of mapping real-world coordinates to a 3D hole model for generating representations of real-world events in the 3D hole model for rending within an extended reality environment by a spatial computing device. The method includes using known coordinates of monuments, such as irrigation system components, represented in the 3D hole model for each hole to align the monuments in the 3D model with the real-world coordinates. An origin point is then set for each hole to ensure real-world shot data of shots line up on the 3D hole model. An offset move is set from real world coordinates to move the 3D model back to the origin point to keep original information intact. The 3D hole model is then rotated into the correct position. The 3D hole model is exported from Z up to Y up. In one example, the exported 3D hole models may be dynamically downloaded to a XR processing unit and loaded into memory. Using an event vision application, the origin point may be read. Shot trail code may be applied. An offset back to the origin point is applied to line the shot trail up with the 3D model. In a further example, a 3D flag model may be dynamically downloaded, imported into the 3D hole model, and the offset back is applied. An offset value for the flag and shot trails per model may be proved to fine tune the experience.

The system 10, e.g., units, or components thereof, and methods described herein may find use in applications beyond golf. For example, the system 10 and methods may be used to enable manipulation and graphic creation of event-related data with respect to other sports or events, such as elections. The system 10 and methods disclosed herein may include still further functionalities and features. For example, the operative functions of the system 10 and method may be configured to execute on a special-purpose processor specifically configured to carry out the operations provided by the system 10 and method. Notably, the operative features and functionality provided by the system 10 and method may increase the efficiency of computing devices that are being utilized to facilitate the functionality provided by the system 10 and the various methods disclosed herein. For example, a reduced amount of computer operations may need to be performed by the devices and elements in the system 10 using the processors and memories of the system 10 than compared to traditional methodologies. In such a context, less processing power needs to be utilized because the processors and memories do not need to be dedicated for processing. As a result, there are substantial savings in the usage of computer resources by utilizing the software, techniques, protocols, and algorithms provided in the present disclosure. In certain embodiments, various operative functionality of the system 10 may be configured to execute on one or more graphics processors and/or application specific integrated processors. In some embodiments, various functions and features of the system 10 and methods may operate without any human intervention and may be conducted entirely by computing devices. In certain embodiments, for example, numerous computing devices may interact with devices of the system 10 to provide the functionality supported by the system 10. Additionally, in certain embodiments, the computing devices of the system 10 may operate continuously and without human intervention to reduce the possibility of errors being introduced into the system 10.

While certain manipulation and navigation features are identified with respect to hole views and immersion views, the system 10 may be configured to enable the identified manipulations and navigations with respect to any view such that users may view the mapped content from multiple perspectives or points of view.

Referring now also to FIG. 14, at least a portion of the methodologies and techniques described with respect to the exemplary embodiments of the system 10 can incorporate a machine, such as, but not limited to, computer system 800, or other computing device within which a set of instructions, when executed, may cause the machine to perform any one or more of the methodologies or functions discussed above. The machine may be configured to facilitate various operations conducted by the system 10. For example, the machine may be configured to, but is not limited to, assist the system 10 by providing processing power to assist with processing loads experienced in the system 10, by providing storage capacity for storing instructions or data traversing the system 10, or by assisting with any other operations conducted by or within the system 10. As another example, the computer system 800 may assist with obtaining event-related data, data transmission, modification of event-related data, data importation, data storage, data processing, data translation, data mapping, updates to any thereof, or a combination thereof, present in an environment being monitored by the system 10. As another example, the computer system 800 may assist with output, distribution, or both of updates or assembling or compiling modified event or other data for delivery or distribution to clients, for television broadcast, streaming broadcasts, onsite display, offsite display, digital platforms for viewing, manipulating, formatting, or combination thereof of the same.

In some embodiments, the machine may operate as a standalone device. In some embodiments, the machine may be connected to and assist with operations performed by other machines and systems, such as, but not limited to, any functionality, generator, simulator, database, engine, of other functionality described herein, any of which may be provided by such other machines or systems to the machine for use by system 10 in performance of the operations described herein. The machine may be connected with any component in the system 10. In a networked deployment, the machine may operate in the capacity of a server or a client user machine in a server-client user network environment, or as a peer machine in a peer-to-peer (or distributed) network environment. The machine may operate in a cloud environment in which resources are distributed. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 800 may include a processor 802 (e.g., a central processing unit (CPU), a graphics processing unit (GPU, or both), a main memory 804 and a static memory 806, which communicate with each other via a bus 808. The computer system 800 may further include a video display unit 810, which may be, but is not limited to, a liquid crystal display (LCD), a flat panel, a solid state display, or a cathode ray tube (CRT). The computer system 800 may include an input device 812, such as, but not limited to, a keyboard, a cursor control device 814, such as, but not limited to, a mouse, a disk drive unit 816, a signal generation device 818, such as, but not limited to, a speaker or remote control, and a network interface device 820. The network interface device 835 may handle data communications for other devices, modules, units, or components of the system 10 or another system or machine.

The disk drive unit 816 may include a machine-readable medium 822 on which is stored one or more sets of instructions 824, such as, but not limited to, software embodying any one or more of the methodologies or functions described herein, including those methods illustrated above. The instructions 824 may also reside, completely or at least partially, within the main memory 804, the static memory 806, or within the processor 802, or a combination thereof, during execution thereof by the computer system 800. The main memory 804 and the processor 802 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system 10 is applicable to software, firmware, and hardware implementations.

In accordance with various embodiments of the present disclosure, methods described herein are intended for operation as software programs running on a computer processor. Furthermore, software implementations can include, but not limited to, distributed processing or component/object distributed processing, parallel processing, or virtual machine processing can also be constructed to implement the methods described herein. As an example, the XR processing unit 20 or functions thereof may be distributed, e.g., comprise or execute within a cloud computing environment. In one embodiment, one or both of the memory 22 or the processor 26 or functions thereof may be distributed. Example distribution may include a network environment, cloud computing environment, spatial computing device 40, or combination thereof. For instance, all or a portion of memory 22, processor 26, or the storage or processing operations thereof may be distributed or otherwise shared between or among multiple memory, processors, networks, machines, or the like, which may include between or among memory or processers within a distributed or cloud computing environment that, in one embodiment, may include the spatial computing device.

The present disclosure contemplates a machine-readable medium 822 containing instructions 824 so that a device connected to the communications network 835, another network, or a combination thereof, can send or receive voice, video or data, and communicate over the communications network 835, another network, or a combination thereof, using the instructions. The instructions 824 may further be transmitted or received over the communications network 835, another network, or a combination thereof, via the network interface device 820.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

In a first aspect, a system for providing an extended reality environment configured to incorporate real-world event data into 3D models representative of the real-world event within the extended reality environment, the system comprising: an XR processing unit comprising a processor and memory and configured to execute an event vision application to perform operations, the operations comprising: dynamically downloading 3D hole models of the course; receiving real-world live shot data of shots taken on the holes during a golf tournament; mapping the shot data to the 3D hole models; causing a spatial computing device to render hole views and immersive views comprising the mapped shot data rendered directly on the 3D hole models in real-time in an interactive extended reality environment, wherein the mapped shot data comprises shot trails representative of the shots taken on the golf course, and wherein the hole views and immersive views utilize the same source file.

The system of paragraph 113, wherein the operations comprise receiving user interaction data with respect to rendered views, the user interaction data collected by the spatial computing device.

The system of paragraph 113, wherein the operations further comprise receiving user interaction data to switch between a hole view and an immersive view and providing seamless navigation within 3D hole models between hole views and immersive views.

The system of any one of paragraphs 113-115, wherein the rendered hole views and immersive views comprising the mapped shot data rendered directly on the 3D hole models enables the spatial computing device to provide seamless navigation within 3D hole models between hole views and immersive views.

The system of any one of paragraphs 113-116, wherein the XR processing unit is configured to receive the live shot data from a live data source that maintains coordinate data collected by a tracking system comprising one or more coordinate sources that monitor location and movement of balls and other objects during the golf tournament.

The system of paragraph 117, wherein the XR processing unit is configured to receive live tracking data with respect to scoring for incorporation into the views rendered by the spatial computing device.

The system of paragraph 117 or 118, wherein the XR processing unit is configured to receive live tracking data with respect to positions of players during the golf tournament for incorporation into the views rendered by the spatial computing device.

The system of any one of paragraphs 113-119, wherein the XR processing unit is configured to receive the shot data from a live data source that maintains predictions generated by a prediction generator for the shots based on initial shot trajectory determined from one or more sensors of a tracking system comprising radar, lasers, cameras, or combination thereof.

The system of paragraph 120, wherein a prediction generator comprises or accesses a database including one or both of course maps or location information with respect to radar, lasers, or cameras supplying ball flight information to identify locations, coordinates, ground characteristics, or combination thereof to improve predictions of final resting coordinates of the balls.

The system of paragraph 120 or 121, wherein the prediction generator takes ball flight parameters collected by radar coordinate sources and applies AI to make an educated guess on final resting coordinates of balls.

The system of any one of paragraphs 113-122, wherein the XR processing unit is configured to receive historical statistics with respect to play during previous golf tournaments for incorporation into the views rendered by the spatial computing device.

The system of any one of paragraphs 113-123, wherein the XR processing unit is configured to provide the spatial computing device score card data including scoring data of players competing in the golf tournament that the spatial computing device renders within a 2D window comprising a scorecard panel view that overlays a portion of the hole or immersive hole views.

The system of paragraph 124, wherein the scorecard panel view includes interactive elements that are selectable by a user to cause display of scorecards from previous rounds.

The system of paragraph 124 or 125, wherein the scorecard panel view includes interactive elements to select a hole or score with respect to a displayed scorecard of a player that when selected causes the spatial computing device to render hole or immersive hole view of the selected hole.

The system of paragraph 126, wherein the XR processing unit is configured to provide mapped shot data of shots taken by the player on the hole the score relates for rending by the spatial computing device to enable replay of one or more of the shots within the hole or immersive hole view.

The system of any one of paragraphs 124-127, wherein the XR processing unit is configured to provide mapped shot data for rending by the spatial computing device comprising views comprising a scatter plot of actual shot locations of shots taken on a hole overlaid onto the 3D hole model of the hole.

The system of any one of paragraphs 113-129, wherein the operations further comprise causing display of 2D windows that the spatial computing device overlaying hole or immersive hole views.

The system of paragraph 129, wherein the 2D windows comprise a leaderboard board panel view that displays current scoring information for the tournament.

The system of paragraph 129 or 130, wherein the 2D windows comprise a scorecard panel view that displays scorecards of a user selected player.

The system of any one of paragraphs 129-131, wherein the 2D windows comprise a course view panel that displays view and live scoring information about holes of the course.

The system of paragraph 132, wherein the course view panel comprises interactive elements with respect to the holes that users may select to view a selected hole or hole view.

The system of any one of paragraphs 129-133, wherein the 2D windows comprise a schedule and tournament details panel view comprising a display of upcoming and completed tournaments.

The system of any one of paragraphs 129-134, wherein the 2D windows comprise a current player rankings view.

The system of any one of paragraphs 113-135, wherein the 3D hole models use universal scene description zip files hosted on a cloud computing services.

The system of any one of paragraphs 113-136, wherein 3D hole models of holes are mapped using monuments within a real-world space of the hole.

The system of paragraph 137, wherein the monuments have known coordinates and spatial relationships, and wherein the known coordinates are defined within a same coordinate space as real-world coordinates mapped to the 3D models in the extended reality environment.

The system of paragraph 137 or 138, wherein the shot trails are mapped from real-world coordinates of the shots in the shot data using coordinates of the 3D hole model relative to the coordinates of the monuments such that the mapped shot trails are representative of the shots taken on the hole of the golf course.

The system of any one of paragraphs 113-139, wherein the 3D hole models are dynamically downloaded to the memory at user initiation of the event vision application via the spatial computing device.

The system of any one of paragraphs 113-140, wherein the operations further comprising providing, applying, or both an offset value for the 3D hole flag model or shot trails per the 3D hole model to fine tune the extended reality experience within the extended realty environment.

The system of paragraph 141, wherein the offset value is applied to conform the 3D hole model space to the real-world space it represents.

The system of paragraph 142, wherein application of the offset value shifts location of the flag, shot trails, or both in the 3D hole model to new coordinates of 3D model.

The system of any one of paragraphs 113-143, wherein the 3D hole models are generated and mapped using irrigation system data for each hole to make sure they line up properly with real world coordinates.

The system of any one of paragraphs 113-144, wherein the 3D hole models are generated and mapped using monument data for each hole to ensure alignment of the 3D hole model with real-world coordinates.

The system of any one of paragraphs 113-145, wherein the operations further include: setting an origin point for the holes for use of the origin points to line up real-world coordinates of shots taken on the holes with the 3D hole models; setting an offset move from real-world coordinates to move the 3D hole model backs to the origin points; and rotating the 3D hole models on the origin points to align with known real-world monument coordinates; wherein, if 3D axis orientation differs between received real-world coordinates and the 3D hole model coordinates, exporting the respective 3D hole models to the corresponding axis orientation to conform with the defined axis orientation employed by the real-world coordinates.

The system of any one of paragraphs 113-146, wherein the operations further include: receiving shot data comprising real-world coordinates from play on the real-world hole; reading the origin point and applying it to a shot trail code corresponding to the real-world coordinates of the shot; applying an offset back to the origin point to line the shot trail with the 3D hole model; and syncing 3D hole models relative to real-world coordinates to ensure overlaid data representing real-world shot data within the real-world space of a hole lines up with the 3D model space.

The system of any one of paragraphs 113-147, wherein the operations further comprise using real-world coordinates of locations of known monuments on a golf hole to ensure depictions of shots generated from real-world coordinates align with a 3D hole model of the hole.

The system of any one of paragraphs 113-148, wherein the operations further comprise generating and mapping the 3D hole models using known monument locations and coordinates on the golf course.

The system of paragraph 149, wherein the known monument locations comprise irrigation system components.

The system of any one of paragraphs 99-136, wherein the 3D hole models are dynamically downloaded into memory of an XR processing unit during real-world play on the golf hole.

The system of any one of paragraphs 113-151, wherein the real-world coordinates comprise GPS coordinates.

The system of any one of paragraphs 113-152, wherein the operations further comprise importing a separate 3D flag model for a hole flag for the hole into the 3D hole model.

The system of paragraph 153, wherein the real-world coordinates for the hole flag are obtained before each round and are mapped to the 3D hole model by reading the origin point, applying it to the shot trail code and then applying an offset back to origin.

The system of paragraph 154, wherein the operations further fine-tuning the mapping comprising determining or receiving an offset value for the flag and shot trails per the 3D hole model to fine-tune the extended reality experience.

The system of any one of paragraphs 113-155, wherein live shot data processed by the XR processing unit to map shot trails to the 3D hole models comprise real-world coordinate data comprising coordinates for starting location and ending location of a ball.

The system of paragraph 156, wherein the live shot data comprises real-world coordinate data including coordinates for impact location, impact locations for bounce, roll locations, or other ball or flight path coordinates.

The system of any one of paragraphs 113-157, wherein the live shot data comprises real-world coordinate data including ball flight including apex.

The system of any one of paragraphs 113-158, wherein the XR processing unit is configured to translate imported real-world coordinates to 3D the model coordinates.

The system of any one of paragraphs 113-159, wherein the operations further comprise setting an origin point for each hole to define coordinate space values within the 3D hole model.

The system of paragraph 160, wherein the origin point may be selected as any coordinate point on the respective hole.

The system of paragraph 160 or 161, wherein the operations further comprises setting an offset move from real-world coordinates to move the 3D model back to the origin.

The system of any one of paragraphs 160-162, wherein a monument represented in the aligned 3D hole model having known real-world coordinates is used to set an offset coordinate value from the origin.

The system of any one of paragraphs 113-165, wherein the operations further comprise using multiple known points comprising known real-world coordinates of monuments on the hole that are represented in the 3D hole model, and rotating the 3D hole model on the origin to meet the real-world coordinates with the corresponding 3D hole model coordinates.

In a second aspect, a method of spatial mapping live, real-world event coordinates with respect to golf tournament to a 3D model for rending extended realty displays of the golf tournament using the system of any one of paragraphs 113-164.

In a third aspect, a method of mapping shot data to a 3D hole model to support rending of the mapped shot data in 3D hole model in a extended reality environment comprises receiving, from a live data source, stats library, or both, real-world coordinates corresponding to a real-world shot taken during play of a golf tournament on a hole of a golf course; reading an origin point of a 3D hole model of the hole of the golf course and applying a shot trail code generated from the real-world coordinates corresponding to the real world shot; applying an offset back to an origin set for the 3D hole model to line the shot trail represented by the shot trail code with the 3D hole model; generating or receiving a separate 3D flag model for a hole flag for the hole of the golf course; and importing the 3D flag model into the 3D hole model.

The method of paragraph 166, further comprising obtaining real-world coordinates for the hole flag and mapping to the 2D hole model by reading the origin point, applying it to the shot trail code, and then applying an offset back to origin.

The method of paragraph 166 or 167, further comprising providing an offset value for the 3D hole flag model or shot trails per the 3D hole model to fine tune the extended reality experience within the extended realty environment.

The method of paragraph 168, wherein the offset is applied to conform the 3D hole model space to the real-world space it represents.

The method of paragraph 169, wherein application of the offset value shifts location of the flag, shot trails, or both in the 3D hole model to new coordinates of 3D model.

In a fourth aspect, a method of spatial mapping live, real-world golf event coordinates to a 3D hole model for rending displays comprising extended realty views of the golf tournament incorporating mapped shot data rendered directly on 3D hole models comprises generating and mapping 3D hole models using monument data for each hole to ensure alignment of the 3D hole model with real-world coordinates, wherein the monument data comprises known real-world coordinates for monuments represented in the respective 3D hole models; setting an origin point for each hole to ensure shots line up on the 3D hole model; setting an offset move from real world coordinates to move the 3D hole model back to the origin point; rotating the 3D hole model into correct position; exporting the 3D hole model from Z up to Y up; dynamically downloading the 3D hole model and loading it into memory; reading the origin point and applying it to shot trail code; and applying an offset back to 0, 0, 0, (origin) to line up with the 3D hole model.

The method of paragraph 157, further comprising incorporating a 3D flag model representative of a flag position on the hole and applying an offset back to 0, 0, 0 (origin) to line up the 3D flag model with the 3D hole model.

The method of paragraph 158, further comprising providing an offset value for the flag and shot trail per the 3D hole model to fine tune the extended reality experience.

The method of any one of paragraphs 157-159, wherein the offset is applied to conform the 3D hole model space to the real-world space it represents.

The method of any one of paragraphs 157-160, wherein application of the offset value shifts location of the flag, shot trails, or both in the 3D hole model to new coordinates of 3D model.

In a fifth aspect, a method of spatial mapping live, real-world event coordinates to a 3D model to render shot trails therein for providing an immersive extended reality experience comprises dynamically downloading a 3D hole model of a hole of a golf course to memory of a device that executes an event vision application or that is in data communication with the event vision application, wherein the 3D hole model was mapped using monuments represented in the 3D hole model having known coordinates within a real-world space of the hole; and mapping, to the 3D hole model, real-world shot data from shots taken on the hole of the golf course during a golf tournament, wherein the real-world shot data includes real-world coordinates of shots and the mapping includes mapping shot depictions from the real-world coordinates of the shots using coordinates of the 3D hole model relative to the coordinates of the monuments such that the mapped shot depictions are representative of the shots taken on the hole of the golf course, and wherein the mapped shot depictions are rendered by a spatial computing device to generate one more vies comprising interactive displays of the shot depictions within the 3D hole model that provides an extended reality environment within which display of real-world events of the golf tournament are represented.

The method of paragraph 176, wherein the monuments have known coordinates and spatial relationships, and wherein the known coordinates are defined within a same coordinate space as real world coordinates that are spatially mapped to the 3D hole model in the extended reality environment.

The method of paragraph 176 or 178, wherein the device that executes the event vision application is the spatial computing devices.

The method of any one of paragraphs 176-178, wherein the mapped shot data is displayed directly on the 3D hole models.

The method of any one of paragraphs 176-179, further comprising using real-world coordinates of locations of known monuments on a golf hole to ensure depictions of shots generated from real-world coordinates align with a 3D hole model of the hole.

The method of any one of paragraphs 176-180, further comprising generating and mapping the 3D hole models.

The method of any one of paragraphs 176-181, wherein the known monuments comprise irrigation system components.

The method of any one of paragraphs 176-182, wherein shot depictions are layered directly onto the 3D hole models, and wherein the shot depictions comprise shot trails.

The method of any one of paragraphs 176-183, further comprising setting an origin point for the hole for use of the origin point to line up the real-world coordinates of the shots with a 3D hole model; setting an offset move from the real-world coordinates to move the 3D hole model back to the origin point; and rotating the 3D hole model on the origin point to align with coordinates of the monuments; wherein, if 3D axis orientation differs between received real-world coordinates and the 3D hole model coordinates, exporting the model to the corresponding axis orientation to conform with the defined axis orientation employed by the real-world coordinates.

The method of paragraph 184, wherein setting the origin point, setting the offset move, and rotating the hole model on the origin point are performed for a plurality of holes on the golf course with respect to a plurality of 3D hole models.

The method of paragraph 185, wherein the plurality of 3D hole models are dynamically downloaded from a data source during real-world play on the golf course and used to map live shot data from play on the real-world hole to the 3D hole models for generating the shot depictions, and wherein the shot depictions comprise shot trail.

The method of paragraphs 185 or 186, further comprising importing separate 3D flag models for the plurality of holes into corresponding 3D hole models.

The method of paragraph 187, wherein the real-world coordinates for the hole flags are obtained before each round and are mapped to the corresponding 3D hole models by reading the origin point, applying it to the shot trail code and then applying an offset back to origin.

The method of any one of paragraphs 176-188, wherein the real-world coordinates comprise GPS coordinates.

The method of any one of paragraphs 176-189, further comprising importing a separate 3D flag model for a hole flag for the hole into the 3D hole model.

The method of paragraph 190, wherein the shot depictions comprises a shot trail, and wherein the real-world coordinates for the hole flag are obtained before each round and are mapped to the 3D hole model by reading the origin point, applying it to the shot trail code and then applying an offset back to origin.

The method of paragraph 190 or 191, further comprising fine-tuning the mapping comprising determining or receiving an offset value for the flag and shot trails per the 3D hole model to fine-tune the extended reality experience.

The method of any one of paragraphs 176-192, further comprising syncing the 3D hole model relative to real-world coordinates to ensure overlaid data representing real-world data within the real-world space of the hole lines up with the 3D model space.

The method of paragraph 193, wherein live shot data is processed by an XR processing unit to generate the shot depictions comprising shot trails, and wherein the real-world coordinate of shots include starting location and ending location of shots.

The method of paragraph 194, wherein the real-world coordinate data further comprises coordinates for impact location, impact locations for bounce, roll locations, or other ball or flight path coordinates.

The method of paragraph 194 or 195, wherein the real-world coordinate data further comprises apex.

The method of any one of paragraphs 176-196, wherein shot data is processed by an XR processing unit configured to translate imported real-world coordinates to 3D the model coordinates.

The method of any one of paragraphs 176-197, wherein an origin point is set for each hole and used to define coordinate space values within the 3D hole model.

The method of paragraph 198, wherein the origin point may be selected as any coordinate point on the respective hole.

The method of paragraph 198 or 199, further comprising setting an offset move from real-world coordinates to move the 3D model back to the origin.

The method of paragraph 200, wherein a monument represented in the aligned 3D hole model having known real-world coordinates is used to set an offset coordinate value from the origin.

The method of any one of paragraphs 198-201, further comprising using multiple known points comprising known real-world coordinates of monuments on the hole that are represented in the 3D hole model, and rotating the 3D hole model on the origin to meet the real-world coordinates with the corresponding 3D hole model coordinates.

The method of any one of paragraphs 176-202, further comprising receiving user interaction data with respect to one or more of the rendered views, the user interaction data collected by the spatial computing device.

The method of any one of paragraphs 176-203, further comprising receiving user interaction data to switch between a hole view and an immersive view and providing seamless navigation within 3D hole models between hole views and immersive views.

The method of any one of paragraphs 176-204, wherein rendered hole views and immersive views comprise the mapped shot data rendered directly on the 3D hole models that the spatial computing device uses to provide seamless navigation within 3D hole models between hole views and immersive views.

The method of any one of paragraphs 176-205, wherein hole views and immersive views utilize the same source file and enable seamless transition between the hole views and immersive views.

The method of any one of paragraphs 176-1206, further comprising receiving live shot data from a live data source that maintains coordinate data collected by a tracking system comprising one or more coordinate sources that monitor location and movement of balls and other objects during the golf tournament.

The method of paragraph 207, further comprising receiving live tracking data with respect to scoring for incorporation into views of the 3D hole model and shot data rendered by the spatial computing device.

The method of paragraph 207 or 208, further comprising receiving live tracking data with respect to positions of players during the golf tournament for incorporation into the views rendered by the spatial computing device.

The method of any one of paragraphs 176-209, further comprising receiving the shot data from a live data source that maintains predictions generated by a prediction generator for the shots based on initial shot trajectory determined from one or more sensors of a tracking system comprising radar, lasers, cameras, or combination thereof.

The method of any one of paragraphs 176-210, wherein a prediction generator comprises or accesses a database including one or both of course maps or location information with respect to radar, lasers, or cameras supplying ball flight information to identify locations, coordinates, ground characteristics, or combination thereof to improve predictions of final resting coordinates of the balls.

The method of paragraph 211, wherein the prediction generator takes ball flight parameters collected by radar coordinate sources and applies AI to make an educated guess on final resting coordinates of balls.

The method of any one of paragraphs 176-212, comprising receiving historical statistics with respect to play during previous golf tournaments for incorporation into the views rendered by the spatial computing device.

The method of any one of paragraphs 176-213, wherein further comprising providing the spatial computing device score card data including scoring data of players competing in the golf tournament that the spatial computing device renders within a 2D window comprising a scorecard panel view that overlays a portion of the hole or immersive hole views.

The method of paragraph 214, wherein the scorecard panel view includes interactive elements that are selectable by a user to cause display of scorecards from previous rounds.

The method of paragraph 214 or 215, wherein the scorecard panel view includes interactive elements to select a hole or score with respect to a displayed scorecard of a player that when selected causes the spatial computing device to render hole or immersive hole view of the selected hole.

The method of any one of paragraphs 214-216, further comprising providing mapped shot data of shots taken by the player on the hole the score relates for rending by the spatial computing device to enable replay of one or more of the shots within the hole or immersive hole view.

The method of any one of paragraphs 176-217, further comprising providing mapped shot data for rending by the spatial computing device comprising views comprising a scatter plot of actual shot locations of shots taken on a hole overlaid onto the 3D hole model of the hole.

The method of any one of paragraphs 176-218, further comprising causing display of 2D windows that the spatial computing device overlaying hole or immersive hole views.

The method of paragraph 219, wherein the 2D windows comprise a leaderboard board panel view that displays current scoring information for the tournament.

The method of paragraph 219 or 220, wherein the 2D windows comprise a scorecard panel view that displays scorecards of a user selected player.

The method of any one of paragraphs 219-221, wherein the 2D windows comprise a course view panel that displays view and live scoring information about holes of the course.

The method of paragraph 222, wherein the course view panel comprises interactive elements with respect to the holes that users may select to view a selected hole or hole view.

The method of any one of paragraphs 219-223, wherein the 2D windows comprise a schedule and tournament details panel view comprising a display of upcoming and completed tournaments.

The method of any one of paragraphs 219-224, wherein the 2D windows comprise a current player rankings view.

The method of any one of paragraphs 176-225, wherein the 3D hole models use universal scene description zip files hosted on a cloud computing services.

In a sixth aspect, a method of spatial mapping live, real-world event coordinates with respect to golf tournament to a 3D model for rending extended realty displays of the golf tournament using the method of any one of paragraphs 165-226.

A non-transient computer readable medium that when executed by a processor performs the method of any one of paragraphs 165-227.

What is claimed is:

1. A system for providing an extended reality environment configured to incorporate real-world event data into 3D models representative of the real-world event within the extended reality environment, the system comprising:
an XR processing unit comprising a processor and memory and configured to execute an event vision application to perform operations, the operations comprising:
dynamically downloading 3D hole models of the course;
receiving real-world live shot data of shots taken on the holes during a golf tournament;
mapping the shot data to the 3D hole models;
causing a spatial computing device to render hole views and immersive views comprising the mapped shot data rendered directly on the 3D hole models in real-time in an interactive extended reality environment, wherein the mapped shot data comprises shot trails representative of the shots taken on the golf course, and wherein the hole views and immersive views utilize the same source file.

2. The system of claim 1, wherein the operations comprise receiving user interaction data with respect to rendered views, the user interaction data collected by the spatial computing device.

3. The system of claim 2, wherein the operations further comprise receiving user interaction data to switch between a hole view and an immersive view and providing seamless navigation within 3D hole models between hole views and immersive views.

4. The system of claim 1, wherein the rendered hole views and immersive views comprising the mapped shot data rendered directly on the 3D hole models enables the spatial computing device to provide seamless navigation within 3D hole models between hole views and immersive views.

5. The system of claim 1, wherein the XR processing unit is configured to receive the live shot data from a live data source that maintains coordinate data collected by a tracking system comprising one or more coordinate sources that monitor location and movement of balls and other objects during the golf tournament.

6. The system of claim 1, wherein the XR processing unit is configured to receive the shot data from a live data source that maintains predictions generated by a prediction generator for the shots based on initial shot trajectory determined from one or more sensors of a tracking system comprising radar, lasers, cameras, or combination thereof.

7. The system of claim 6, wherein a prediction generator comprises or accesses a database including one or both of course maps or location information with respect to radar, lasers, or cameras supplying ball flight information to identify locations, coordinates, ground characteristics, or combination thereof to improve predictions of final resting coordinates of the balls.

8. The system of claim 6, wherein the prediction generator takes ball flight parameters collected by radar coordinate sources and applies AI to make an educated guess on final resting coordinates of balls.

9. The system of claim 1, wherein the XR processing unit is configured to provide the spatial computing device score card data including scoring data of players competing in the golf tournament that the spatial computing device renders within a 2D window comprising a scorecard panel view that overlays a portion of the hole or immersive hole views.

10. The system of claim 9, wherein the scorecard panel view includes interactive elements to select a hole or score with respect to a displayed scorecard of a player that when selected causes the spatial computing device to render hole or immersive hole view of the selected hole, and wherein the XR processing unit is configured to provide mapped shot data of shots taken by the player on the hole the score relates for rending by the spatial computing device to enable replay of one or more of the shots within the hole or immersive hole view.

11. The system of claim 1, wherein the operations further comprise causing display of 2D windows that the spatial computing device overlaying hole or immersive hole views.

12. The system of claim 11, wherein the 2D windows comprise a leaderboard board panel view that displays current scoring information for the tournament.

13. The system of claim 12, wherein the 2D windows comprise a course view panel that displays view and live scoring information about holes of the course, and wherein the course view panel comprises interactive elements with respect to the holes that users may select to view a selected hole or hole view.

14. The system of claim 1, wherein 3D hole models of holes are mapped using monuments within a real-world space of the hole.

15. The system of claim 14, wherein the monuments have known coordinates and spatial relationships, and wherein the known coordinates are defined within a same coordinate space as real-world coordinates mapped to the 3D models in the extended reality environment.

16. The system of claim 15, wherein the shot trails are mapped from real-world coordinates of the shots in the shot data using coordinates of the 3D hole model relative to the coordinates of the monuments such that the mapped shot trails are representative of the shots taken on the hole of the golf course.

17. The system of claim 1, wherein the operations further comprising providing, applying, or both an offset value for the 3D hole flag model or shot trails per the 3D hole model to fine tune the extended reality experience within the extended realty environment.

18. The system of claim 17, wherein the offset value is applied to conform the 3D hole model space to the real-world space it represents.

19. The system of claim 18, wherein application of the offset value shifts location of the flag, shot trails, or both in the 3D hole model to new coordinates of 3D model.

20. The system of claim 1, wherein the operations further include:
setting an origin point for the holes for use of the origin points to line up real-world coordinates of shots taken on the holes with the 3D hole models;
setting an offset move from real-world coordinates to move the 3D hole model backs to the origin points; and
rotating the 3D hole models on the origin points to align with known real-world monument coordinates;
wherein, if 3D axis orientation differs between received real-world coordinates and the 3D hole model coordinates, exporting the respective 3D hole models to the corresponding axis orientation to conform with the defined axis orientation employed by the real-world coordinates.

21. The system of claim 1, wherein the operations further include:
receiving shot data comprising real-world coordinates from play on the real-world hole;
reading the origin point and applying it to a shot trail code corresponding to the real-world coordinates of the shot;
applying an offset back to the origin point to line the shot trail with the 3D hole model; and
syncing 3D hole models relative to real-world coordinates to ensure overlaid data representing real-world shot data within the real-world space of a hole lines up with the 3D model space.

22. A method of spatial mapping live, real-world event coordinates to a 3D model to render shot trails therein for providing an immersive extended reality experience, the method comprising:
dynamically downloading a 3D hole model of a hole of a golf course to memory of a device that executes an event vision application or that is in data communication with the event vision application, wherein the 3D hole model was mapped using monuments represented in the 3D hole model having known coordinates within a real-world space of the hole; and
mapping, to the 3D hole model, real-world shot data from shots taken on the hole of the golf course during a golf tournament, wherein the real-world shot data includes real-world coordinates of shots and the mapping includes mapping shot depictions from the real-world coordinates of the shots using coordinates of the 3D hole model relative to the coordinates of the monuments such that the mapped shot depictions are representative of the shots taken on the hole of the golf course, and wherein the mapped shot depictions are rendered by a spatial computing device to generate one more vies comprising interactive displays of the shot depictions within the 3D hole model that provides an extended reality environment within which display of real-world events of the golf tournament are represented.

23. The method of claim 22, wherein the monuments have known coordinates and spatial relationships, and wherein the known coordinates are defined within a same coordinate space as real world coordinates that are spatially mapped to the 3D hole model in the extended reality environment.

24. The method of claim 23, wherein the device that executes the event vision application is the spatial computing devices.

25. The method of claim 22, wherein the mapped shot data is rendered directly on the 3D hole models.

26. A method of spatial mapping live, real-world golf event coordinates to a 3D hole model for rending displays comprising extended realty views of the golf tournament incorporating mapped shot data rendered directly on 3D hole models, the method comprising:
generating and mapping 3D hole models using monument data for each hole to ensure alignment of the 3D hole model with real-world coordinates, wherein the monument data comprises known real-world coordinates for monuments represented in the respective 3D hole models;
setting an origin point for each hole to ensure shots line up on the 3D hole model;
setting an offset move from real world coordinates to move the 3D hole model back to the origin point;
rotating the 3D hole model into correct position;
exporting the 3D hole model from Z up to Y up;
dynamically downloading the 3D hole model and loading it into memory;
reading the origin point and applying it to shot trail code; and
applying an offset back to 0, 0, 0, (origin) to line up with the 3D hole model.

27. The method of claim 26, further comprising incorporating a 3D flag model representative of a flag position on the hole and applying an offset back to 0, 0, 0 (origin) to line up the 3D flag model with the 3D hole model.
